(19) United States
(12) Patent Application Publication
(10) Pub. No.: US 2025/0265347 A1
(43) Pub. Date: Aug. 21, 2025

(54) SYSTEMS AND METHODS FOR EXECUTING CONTROLS ON NATURAL LANGUAGE GENERATION BASED ON PRE-PROCESSING INPUT DATA

(71) Applicant: Capital One Services, LLC, McLean, VA (US)

(72) Inventors: Keith GASSER, Woodbridge, VA (US); Michael James CAUGHEY, Chesterfield, VA (US); Jesús DOMINGUEZMILLER, McLean, VA (US); Peter TANSKI, Marlborough, MA (US); James HARRIS, McLean, VA (US)

(73) Assignee: Capital One Services, LLC, McLean, VA (US)

(21) Appl. No.: 18/444,563

(22) Filed: Feb. 16, 2024

(51) Int. Cl. G06F 21/57; G06F 40/20

(52) U.S. Cl. CPC G06F 21/577; G06F 40/20

(57) ABSTRACT

Systems and methods for executing domain-specific controls on large language model-generated data are disclosed herein. The system may receive a textual communication and provide the textual communication to a first model to generate an output. Based on the output and the textual communication, the system may generate a communication profile. The system may determine that the communication profile satisfies first or second criteria. Based on determining that the communication profile satisfies the first criteria, the system may determine rulesets corresponding to domains and provide the communication to a second model to generate a second output according to these rulesets. Based on determining that the communication profile satisfies the second criteria, the system may cause execution of a termination protocol in lieu of generating the second output.

### BACKGROUND

The proliferation of artificial intelligence and large language models (LLM) has the potential to transform human-computer interactions. LLMs have begun to shape the way in which information is generated and processed, promising to transform the way users may interact with software applications. For example, LLMs may be capable of conversationally interacting with users. However, LLMs, or other natural language generation (NLG) or natural language processing (NLP) methods may be vulnerable to malicious attacks, prompt injection, and data privacy concerns. As such, LLMs may be less than ideal or even harmful where the generated content is used for cybersecurity attacks or other malicious intent.

### SUMMARY

Pre-existing NLG systems enable generation of content, such as written text, based on prompts, descriptions, or ideas. However, in pre-existing systems, content generated from LLMs cannot be controlled due to the black-box nature of model parameters associated with some artificial intelligence models (e.g., neural networks). In some embodiments, as content generated by artificial intelligence models may depend on training data or other information available to the model, pre-existing systems may not enable dynamic control or tuning of outputs during run time. For example, content generated from pre-existing models may include secure or confidential information or information that is unsuitable for the user or application. In some embodiments, the suitability of the generated output can vary by user or application. For example, content generated by an LLM may include information for which only a subset of users is authorized to view, or where such information is only accessible under certain circumstances. As such, pre-existing systems do not have a way to filter such generated content in a domain-specific or user-specific manner prior to generating the model's output. Any subsequent filtering of the generated content may result in inefficient use of resources, as pre-existing systems may require a substantial number of associated model weights and model-related computational resources (e.g., processors, memory, or other components) in order to generate and subsequently evaluate the LLM's output accurately. As such, pre-existing systems are susceptible to causing security breaches or inefficient utilization of computational resources.

Methods and systems are described herein for executing controls on NLG based on pre-processing input data. For example, the system may dynamically evaluate outputs from an LLM to prevent unauthorized conversations or content generation. For example, the system may provide a user's input to a lightweight LLM, with fewer computational constraints or requirements, for example. Based on this input, the lightweight LLM may generate a preliminary output, which the system may evaluate to generate a set of domains (e.g., classifications) associated with the input, as well as corresponding confidence metrics. Based on these confidence metrics, the system may generate a full output using a heavier-weight model according to domain-specific rulesets. In some embodiments, based on these confidence metrics, the system may execute a termination protocol to protect sensitive data. By doing so, the system may pre-emptively terminate processes-such as outputs from LLMs, which are likely unauthorized, malicious, or harmful-on the basis of a lightweight model rather than a heavier-weight model, thereby improving the efficiency of such an evaluation. Moreover, the system may execute evasive action against malicious content or security breaches, while utilizing limited system resources.

In some aspects, the system may receive a textual communication. As an illustrative example, the system may receive an input to a chatbot, such as a prompt or a message. For example, a user may transmit a message requesting credential information (e.g., a password and a username) for another user associated with a secure system, such as a file storage system. The user may provide text in a text box in the form of an array of text strings that include the request (e.g., a question or a sentence). By receiving prompts, queries, or communications from users, the system enables processing of such requests in a user-specific manner through the use of artificial intelligence (e.g., LLMs).

In some aspects, the system may generate a preliminary output based on the user's input using a lightweight model. For example, the system may provide the first textual communication to a first model to generate a first output. In some embodiments, the first model includes a first resource size, and the first resource size may be less than a second resource size associated with a second model. As an illustrative example, the system may provide the input (e.g., a query relating to user credentials) to a first, lightweight LLM that is capable of generating an output in response to the user's query. For example, the system may generate a preliminary output, such as an indication of the user credentials requested by the user, based on a neural network (e.g., a transformer) associated with the LLM. The preliminary output may indicate an answer or a response, such as an array of text strings corresponding to the answer to the user's question. In some embodiments, this first LLM is a version of a second, heavier-weight LLM. For example, the first LLM may include a lesser number of model weight or may have fewer devoted computational resources. By generating a preliminary output, the system enables evaluation of the information likely to be provided by a heavier-weight LLM, thereby enabling pre-emptive action to block or modify generation of the output. As such, the system enables filtering or modification of the generated output prior to provision to the user, thereby preventing associated security breaches.

In some aspects, the system may generate a communication profile based on the textual communication and the output. For example, the system may generate, based on the first textual communication and the first output, a first communication profile. In some embodiments, the first communication profile includes an indication of one or more domains of a plurality of domains for the first textual communication and one or more confidence indicators. In some embodiments, each confidence indicator corresponds to an associated domain. As an illustrative example, the system may categorize the user's input (e.g., prompt or query into a chatbot), as well as the resulting preliminary output from the lightweight model in order to generate the classification profile. For example, based on the query and the output, the system may determine that the conversation is related to a domain associated with user authentication (e.g., by providing the input and output to a classification natural language processing model). In some implementations, the system may determine an associated confidence indicator for the domain indicating a likelihood or confidence that the determined domain corresponds to the nature of the input and preliminary output. For example, the system may determine that there is a 70% chance that the input and output correspond to user authentication and only a 20% chance that the input and output correspond to an administrator task. By doing so, the system enables accurate and nuanced classification of a given conversation or communication into domains, which enables domain-specific handling of the conversation.

In some aspects, the system may determine whether the conversation satisfies various criteria. For example, the system may determine, based on the indication of the domains and the confidence indicators, that the first communication profile satisfies first criteria or second criteria. As an illustrative example, the system may determine that the communication profile indicates that there is high confidence in the communication profile being associated with a user authentication-related domain. Based on this indication, the system may determine that the communication profile satisfies first criteria (e.g., the confidence indicator matches a threshold confidence indicator associated with the first criteria). In some embodiments, the system may determine that the communication profile indicates that there is low confidence in which domain is associated with the input and/or preliminary output. Based on this indication, the system may determine that the communication profile satisfies second criteria. By evaluating the communication profile for satisfaction of various criteria, the system may determine how to handle model outputs accordingly (e.g., which set of rules with which to evaluate generated outputs, or whether to terminate generation of the outputs prior to any potential security breaches). Because the system may perform this evaluation based on preliminary outputs from a lightweight model, the system enables efficient domain-dependent controls on LLM-generated content without use of system resources associated with a heavier-weight model.

In some aspects, the system may determine that the communication profile satisfies first criteria and determine rulesets associated with the domains within the communication profile. For example, based on the first communication profile satisfying the first criteria, the system may determine one or more rulesets corresponding to the domains. As an illustrative example, the system may determine that the input and preliminary output likely correspond to a user authentication-related domain (e.g., with a confidence indicator greater than a threshold confidence indicator) and, therefore, that the conversation satisfies first criteria. Based on this determination, the system may obtain requirements, rules, or information relating to controls that are associated with the identified domain (e.g., user authentication). For example, the system may obtain a ruleset specifying that, for further processing of the input, administrator credentials are required. By doing so, the system may evaluate a given chatbot conversation in a domain-specific manner, enabling dynamic controls to prevent security breaches.

In some aspects, the system may provide the textual communication to a heavier-weight model for generation of a non-preliminary, second output. For example, based on the first communication profile satisfying the first criteria, the system may provide, according to the relevant rulesets, the first textual communication to the second model to generate, for display on a user interface, a second output. As an illustrative example, having determined that the input and preliminary output correspond to a particular domain (e.g., user authentication) with a satisfactory confidence level, the system may proceed to generate a complete output using a more powerful LLM. For example, the system may provide the user's query to an LLM with a greater number of model weights, or with more devoted computational resources. By doing so, the system may provide an output to the user with greater accuracy than the preliminary output provided by the lightweight model, while ensuring that any output is filtered or processed using the appropriate controls (e.g., based on the rulesets associated with the relevant domains).

In some aspects, the system may determine to terminate or deny generation of subsequent outputs in response to determining that the communication profile satisfies second criteria (e.g., instead of the first criteria). For example, based on the first communication profile satisfying the second criteria, the system may cause execution of a termination protocol in lieu of providing, according to the rulesets, the first textual communication to the second model to generate, for display on the user interface, the second output. As an illustrative example, the system may determine that there is insufficient confidence in the domain (e.g., a category of subject matter) associated with the input and preliminary output. The system may determine that the user's query and the preliminary output is likely unrelated to the scope of the stated subject area of the LLM. In some implementations, the system may determine that the preliminary output includes matter that is associated with a security breach (e.g., sensitive or confidential information). Based on these determinations, the system may terminate the conversation (e.g., by displaying a termination message and resetting the chatbot conversation). By doing so, the system may prevent potential security breaches on the basis of the preliminary output, prior to execution of a heavier-weight model. Thus, the system and methods disclosed herein improve the efficiency of preventing security breaches in a domain-specific manner, while utilizing fewer system resources.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative environment for executing controls on LLM-generated output, in accordance with one or more embodiments of this disclosure.

FIG. 2 shows an illustrative schematic of a textual communication, a preliminary output, and a validated output, in accordance with one or more embodiments of this disclosure.

FIG. 3 shows an illustrative flow for evaluating preliminary outputs for domain determination and executing controls based on this determination, in accordance with one or more embodiments of this disclosure.

FIG. 4 shows an illustrative data structure of a communication profile, in accordance with one or more embodiments of this disclosure.

FIG. 5 shows an illustrative data structure of a user activity database, in accordance with one or more embodiments of this disclosure.

FIG. 6 shows an example computing system that may be used in accordance with one or more embodiments of this disclosure.

FIG. 7 shows a flowchart of the operations involved in executing controls on model-generated outputs, in accordance with one or more embodiments of this disclosure.

### DETAILED DESCRIPTION

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

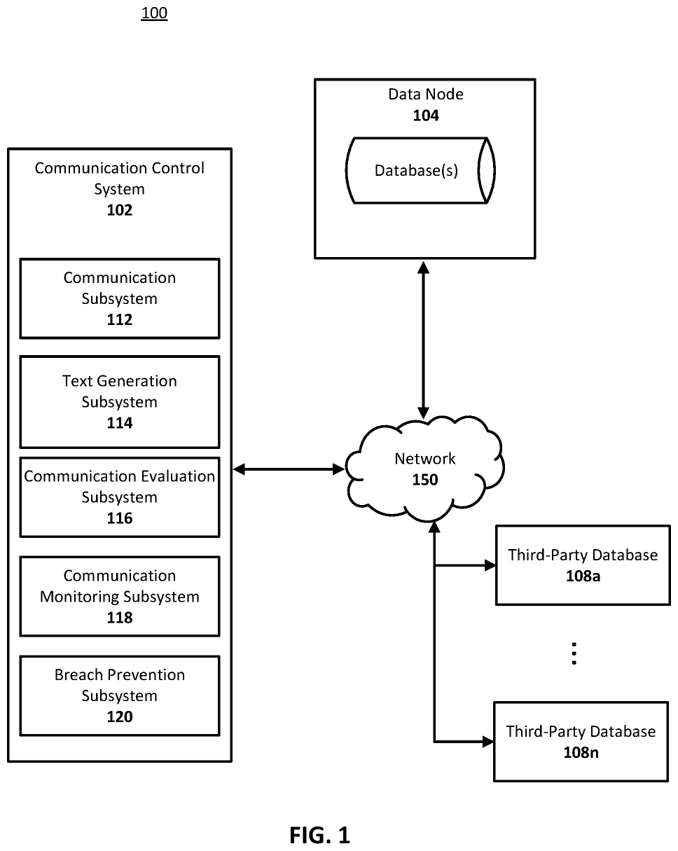

FIG. 1 shows illustrative environment 100 for executing controls on LLM-generated output, in accordance with one or more embodiments of this disclosure. Environment 100 may include communication control system 102, data node 104, or third-party databases 108a-n, any of which may be configured to communicate with network 150. Communication control system 102 may include software, hardware, or a combination of both and may reside on a physical server or a virtual server running on a physical computer system. In some embodiments, communication control system 102 may be configured on a user device (e.g., a laptop computer, smartphone, desktop computer, electronic tablet, or another suitable user device). Furthermore, communication control system 102 may reside on a server or node or may interface with third-party databases 108a-n (e.g., authentication or user activity databases) either directly or indirectly.

Data node 104 may store various data, including textual communications, one or more machine learning models (e.g., model weights associated with an LLM, a generative language model, etc.), outputs of machine learning models, semantic data (e.g., textual communications, text files, or embeddings of such text), or training data (e.g., training textual communications or conversations). Data node 104 may include software, hardware, or a combination of the two. In some embodiments, communication control system 102 and data node 104 may reside on the same hardware or the same virtual server or computing device. Network 150 may be a local area network, a wide area network (e.g., the internet), or a combination of the two. Third-party databases 108a-n may reside on client devices (e.g., desktop computers, laptops, electronic tablets, smartphones, servers, or other computing devices that interact with network 150, cloud devices, or servers).

Communication control system 102 may receive textual communications, training data, rulesets associated with domains, user credential data, or other information from one or more devices. Communication control system 102 may receive such data using communication subsystem 112, which may include software components, hardware components, or a combination of both. For example, communication subsystem 112 may include a network card (e.g., a wireless network card or a wired network card) that is associated with software to drive the card and enables communication with network 150. In some embodiments, communication subsystem 112 may also receive data from or communicate with data node 104 or another computing device. Communication subsystem 112 may receive data such as text files, inputs from users, rulesets, user credential information, authentication probabilities, user activity data, or other suitable data. Communication subsystem 112 may communicate with text generation subsystem 114, communication evaluation subsystem 116, communication monitoring subsystem 118, breach prevention subsystem 120, data node 104, or any devices communicably connected to network 150.

In some embodiments, communication control system 102 may include text generation subsystem 114. Text generation subsystem 114 may perform tasks that generate text, such as outputs or responses to user input. As an illustrative example, text generation subsystem 114 enables generation of words, sentences, or other natural language tokens in response to user queries or prompts. In some embodiments, text generation subsystem 114 may utilize a machine learning model (e.g., a heavyweight or a lightweight LLM) to provide such outputs dynamically and with user interaction, such as in the case of a chatbot. Text generation subsystem 114 may include software components, hardware components, or a combination of both. For example, text generation subsystem 114 may include software components, or may include one or more hardware components (e.g., processors) that are able to execute operations for generating preliminary or validated outputs in response to user questions relating to user authentication within a file system. Text generation subsystem 114 may access data, such as text files, training data, user inputs, domain information, rulesets associated with domains, or other prompts (e.g., audio- or text-based). Text generation subsystem 114 may directly access data, systems, or nodes associated with third-party databases 108a-n and may transmit data to such systems. In some embodiments, text generation subsystem 114 may receive data from or send data to communication subsystem 112, communication evaluation subsystem 116, communication monitoring subsystem 118, breach prevention subsystem 120, data node 104, or any devices communicably connected to network 150 and/or communication control system 102.

Communication evaluation subsystem 116 may execute tasks relating to evaluation of communications. For example, communication evaluation subsystem 116 may evaluate user inputs, such as prompts, and corresponding outputs, such as responses to the prompts, to determine a domain (e.g., a categorization) associated with the communication and response. For example, communication evaluation subsystem 116 may evaluate a confidence level associated with a domain (e.g., is related to user authentication tasks) for a conversation, indicating a likelihood that the conversation is related to the given domain. Communication evaluation subsystem 116 may access data, such as representations of communications (e.g., user inputs and the corresponding model outputs). For example, communication evaluation subsystem 116 may access data, such as semantic representations of textual content (e.g., text files or corresponding natural language tokens associated with a user's input or an LLM's output). Communication evaluation subsystem 116 may directly access data, systems, or nodes associated with third-party databases 108a-n and may be able to transmit data to such nodes (e.g., to obtain user activity data or authentication-related data). Communication evaluation subsystem 116 may receive data or transmit data to other systems or subsystems within environment 100, such as communication subsystem 112, text generation subsystem 114, communication monitoring subsystem 118, breach prevention subsystem 120, data node 104, or any devices communicably coupled to network 150.

Communication monitoring subsystem 118 may execute tasks relating to monitoring outputs generated from machine learning models. For example, communication monitoring subsystem 118 may monitor the output of a heavyweight LLM for whether the output is consistent with a user's input (e.g., a prompt or a query), and whether the output satisfies any rules of a ruleset associated with the domain of the communication. As such, communication monitoring subsystem 118 may include software components, such as natural language processing algorithms, hardware components, or a combination of both. Communication monitoring subsystem 118 may receive (e.g., from communication evaluation subsystem 116 or text generation subsystem 114) information relating to domains associated with the communication (e.g., a chatbot conversation), as well as corresponding rulesets. Communication monitoring subsystem 118 may transmit information to breach prevention subsystem 120 to prevent or filter outputs from text generation subsystem 114 preventatively to mitigate security breaches. In some embodiments, communication monitoring subsystem 118 may receive data from network 150, data node 104, or third-party databases 108a-n. For example, communication monitoring subsystem 118 may communicate with other components of environment 100, such as communication subsystem 112, text generation subsystem 114, communication evaluation subsystem 116, or breach prevention subsystem 120, as well as any other devices communicably linked with network 150.

Breach prevention subsystem 120 may execute tasks relating to preventing prohibited or unsatisfactory communications associated with user input or the resulting output from text generation subsystem 114. For example, breach prevention subsystem 120 may include software components, hardware components, or a combination of both. Breach prevention subsystem 120 enables communication control system 102 to terminate communications (e.g., by executing a termination protocol) where there is insufficient confidence in the domain associated with a chatbot conversation, or where such communications do not meet rules defined by a ruleset associated with a corresponding domain. For example, breach prevention subsystem 120 may access dynamically generated data from text generation subsystem 114 and may determine to terminate further generation of data on the basis of evaluations associated with communication monitoring subsystem 118. As such, breach prevention subsystem 120 may communicate with other components of environment 100, such as communication subsystem 112, text generation subsystem 114, communication evaluation subsystem 116, communication monitoring subsystem 118, data node 104, or any devices communicably linked to network 150.

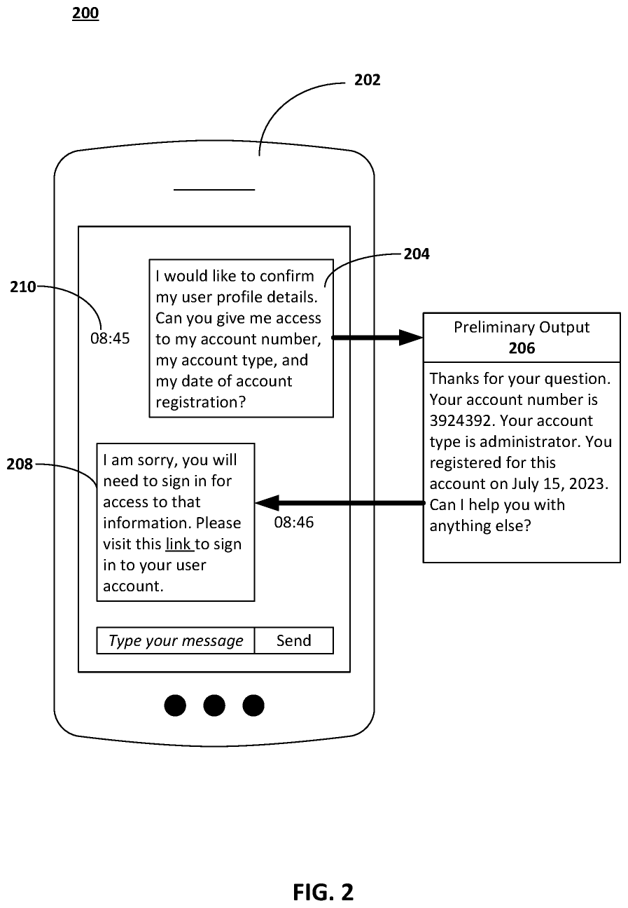

FIG. 2 shows illustrative schematic 200 of a textual communication, a preliminary output, and a validated output, in accordance with one or more embodiments of this disclosure. For example, communication subsystem 112 may receive textual communication 204 at mobile device 202, where the textual communication indicates a query or any other type of user input. In some embodiments, textual communication 204 is associated with timestamp 210. Communication control system 102, through text generation subsystem 114, may generate preliminary output 206 to evaluate the domain and associated confidence metrics for the chatbot conversation, as an illustrative example. Based on this evaluation (e.g., through communication evaluation subsystem 116), communication subsystem 112 may communicate validated output 208 to the user device, thereby preventing any incidental security breaches.

In some embodiments, communication control system 102 may receive a first textual communication (e.g., a query from a user). As an illustrative example, communication subsystem 112 may receive a query or a question from a user utilizing a chatbot interface, where the chatbot interface is associated with an LLM capable of providing responses to such queries. As shown in FIG. 2, textual communication 204 may include a query relating to account or user profile information associated with a user account within a computing system. For example, a user may request information relating to account numbers associated with an online bank account or credit card account, or corresponding balances, dates of registration, or other user-related information. By receiving such information, the system may evaluate the nature of the input and provide validated outputs in response, while preventing disclosure of improper information (e.g., sensitive or confidential information that is not commensurate to the user's credentials).

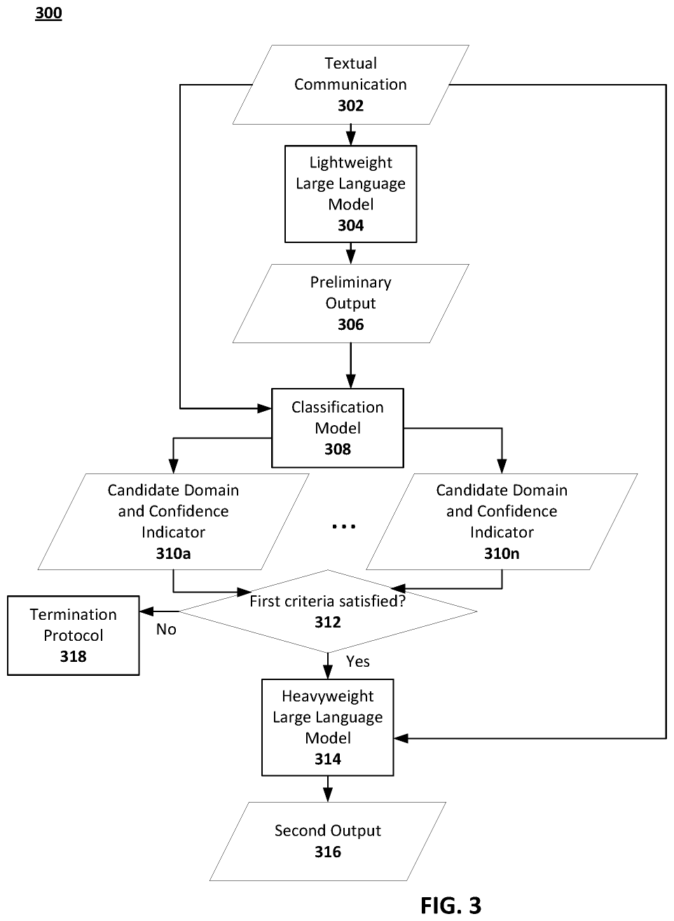

For example, a textual communication may include a verbal, written or signed (as in a sign language) transmission of information. For example, a textual communication may include a query or a question by a user for subsequent NLG, such as a query to a chatbot system capable of providing responses to queries, as shown through textual communication 204 in FIG. 2. In some implementations, textual communication 204 is associated with timestamp 210, enabling tracking of user requests over time. In some embodiments, a textual communication may include information transcribed from audio data (e.g., human speech), such as through a text-to-speech system. A textual communication may include such communications from multiple entities, such as a combination of a query from a first user and a second user, or a combination of a query and a response from an LLM. As such, a textual communication may include a portion or the entirety of a conversation (e.g., a chatbot conversation). By receiving textual communications, communication control system 102 may respond to user queries and provide accurate information in response to these queries (e.g., as shown in validated output 208), while ensuring that such generated responses are consistent with rules or controls imposed by administrator systems (e.g., by filtering out responses, such as those similar to preliminary output 206, as discussed below in relation to FIGS. 3-5).

FIG. 3 shows illustrative flow 300 for evaluating preliminary outputs for domain determination and executing controls based on this determination, in accordance with one or more embodiments of this disclosure. For example, communication control system 102 may receive textual communication 302 (e.g., textual communication 204 shown in FIG. 2). Communication subsystem 112 may transmit textual communication 302 to lightweight LLM 304 for generation of preliminary output 306 (e.g., preliminary output 206 shown in FIG. 2). Based on preliminary output 306 and textual communication 302, communication control system 102 may generate (e.g., using classification model 308) domains and corresponding confidence indicators 310a-n and determine if such a communication profile satisfies first criteria at operation 312. If the communication profile, including domains and associated confidence indicators, indicates that the first criteria are satisfied, communication evaluation subsystem 116 may transmit textual communication 302 to a heavyweight LLM 314 for generation of a second, validated output (e.g., second output 316), with communication monitoring subsystem 118 monitoring any outputs generated for adherence to domain-related rulesets. If the communication profile indicates that second criteria are satisfied instead (e.g., that the first criteria are not satisfied), breach prevention subsystem 120 may execute termination protocol 318 or otherwise prevent a security breach. As such, the systems and methods disclosed herein enable dynamic monitoring and controls for LLM-generated content, including chatbot conversations, in a domain-specific manner.

In some embodiments, communication control system 102 may provide textual communication 302 to a first model to generate an output. For example, communication subsystem 112 may provide the first textual communication to a first model to generate a first output. In some embodiments, the first model includes a first resource size, where the first resource size is less than a second resource size associated with a second model. As an illustrative example, communication subsystem 112 may provide textual communication 302 (e.g., a user query) to lightweight LLM 304, which may include a first, lightweight LLM capable of operating with a lower number of model weights or devoted resources as compared to a second LLM. By doing so, text generation subsystem 114 may generate a preliminary output, using a relatively small amount of computational resources, for the purpose of evaluating the output to ensure prevention of security breaches, as discussed further below. For example, lightweight LLM 304 may generate a sample response to a user query within textual communication 302. To illustrate, lightweight LLM 304 may generate preliminary output 206 as shown in FIG. 2, where preliminary output 206 includes information in response to the user's query in textual communication 204, such as user account information relating to a customer's bank account. For example, preliminary output 206 includes information relating to the user's account number, account type, and registration time, as requested by the user. Such information may be generated by lightweight LLM 304, rather than a heavier-weight LLM, such as heavyweight LLM 314. By doing so, communication control system 102 may obtain an estimated or likely output associated with the user's input, without running a full LLM and without utilizing the associated computational resources. By doing so, text generation subsystem 114 enables evaluation of chatbot conversations (e.g., textual communications from users and resulting outputs) in order to determine the nature of the conversation and prevent any potential security breaches pre-emptively, while efficiently utilizing a lesser number of model resources.

In some embodiments, an LLM may include a language model for generation or processing of language (e.g., natural language, programming languages, or numerical values associated with language). For example, an LLM may include artificial neural networks with multiple model weights and/or hidden layers (e.g., utilizing a transformer-type architecture). In some embodiments, an LLM may utilize probabilistic tokenization of characters, words, or sentences (e.g., by treating language as a set of n-grams). For example, communication control system 102 may train LLMs based on reinforcement learning from human feedback (RLHF), instruction tuning, prompt engineering, or other training algorithms. Text generation subsystem 114 may include multiple heavyweight or lightweight LLMs. A lighter-weight LLM may include an LLM with a smaller resource footprint than a heavier-weight LLM. For example, a lightweight LLM may include a first resource size (e.g., a number of model weights or a number of hidden layers associated with a corresponding artificial neural network) that is lesser than a second resource size associated with a heavyweight LLM. In some embodiments, a resource size can include any indication of computational resources associated with operation, execution, or training a given LLM. For example, a lightweight model may utilize fewer processors, a lower allotment of random access memory, or less storage than a heavyweight model. For example, an LLM may be considered lightweight when one or more resources or features associated with the LLM are smaller than another LLM. In some implementations, an LLM may be considered lightweight when one or more resources or features associated with the LLM are smaller than corresponding threshold values (e.g., a threshold number of model weights or a threshold size).

A preliminary output may include an output from an LLM that is unvalidated or associated with a lighter-weight model. For example, a preliminary output may include a generated set of words, phrases, characters, or sentences in response to an input (e.g., a user query). A lightweight model may generate the preliminary output, such that fewer computational resources may be devoted to the model during generation of the preliminary output as compared to a heavier-weight model. By generating a preliminary output using a lightweight LLM, as opposed to a heavyweight LLM, text generation subsystem 114 may conserve computational resources during evaluation of the input and preliminary output for the categorization or domain of the communication, as well as evaluation of potential security breaches. As such, text generation subsystem 114 provides a resource-efficient manner to enable dynamic evaluation and control of machine learning model-generated outputs prior to transmission to a user (e.g., prior to any security breaches).

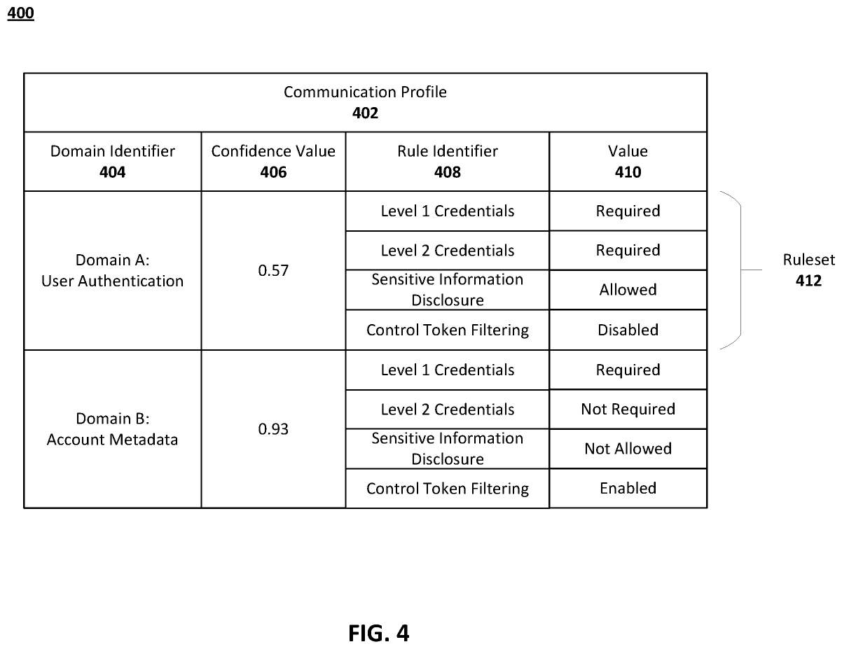

FIG. 4 shows illustrative data structure 400 of communication profile 402, in accordance with one or more embodiments of this disclosure. For example, communication evaluation subsystem 116 may generate communication profile 402, including domain identifiers 404 associated with categorizations of a chatbot conversation, as well as corresponding confidence values 406. In some embodiments, communication evaluation subsystem 116 may identify rules associated with domains, as specified by rule identifiers 408 and corresponding values 410. By evaluating chatbot conversations and other communications for their subject matter (e.g., to determine a domain), as well as a confidence in the determination of these domains, communication evaluation subsystem 116 enables evaluation of which rules and controls to impose on the conversation, thereby improving the ability of communication control system 102 to prevent security breaches or other undesired consequences.

In some embodiments, communication control system 102, through communication evaluation subsystem 116, may generate a communication profile based on the textual communication and the preliminary output. For example, communication evaluation subsystem 116 may generate, based on the first textual communication and the first output, a first communication profile. The first communication profile may include an indication of one or more domains of a plurality of domains for the first textual communication and one or more confidence indicators. In some embodiments, each confidence indicator of the one or more confidence indicators corresponds to an associated domain of the one or more domains. In reference to FIG. 3, communication evaluation subsystem 116 may provide textual communication 302 and preliminary output 306 to classification model 308 in order to generate candidate domains and confidence indicators 310a-310n. As an illustrative example, communication evaluation subsystem 116 may generate a set of domains (e.g., categories) associated with the subject matter within the conversations. In some embodiments, communication evaluation subsystem 116 may generate associated confidence metrics or indicators to quantify or measure the likelihood that these determined domains actually correspond to the categorization or domain of the conversation. By doing so, the system enables pre-processing the user's input (e.g., textual communication 302) based on a preliminary output (e.g., preliminary output 306) for determination of further rules or controls to impose on the conversation.

A communication profile may include information relating to the textual communication (e.g., including both the textual communication obtained from a user, as well as a preliminary or first output generated by a model). For example, a communication profile may include information characterizing the conversation between a user and a chatbot associated with an LLM. A communication profile may include indications of domains associated with the textual communication and the preliminary output, as identified using domain identifiers 404. For example, a domain may include any categorization or classification of conversations, communications, or data. A domain may include a categorization of these communications based on subject matter within the conversation, the time of the conversation, or the users associated with the conversation. As an illustrative example, textual communication 204 shown in FIG. 2, which includes a query for user account information, may be determined to be associated with Domain A (e.g., related to user authentication), and Domain B (e.g., related to account metadata). In some embodiments, communication evaluation subsystem 116 may generate confidence indicators or confidence metrics associated with these domains (e.g., confidence values 406 shown in FIG. 4). By evaluating preliminary outputs and input text for corresponding domains, communication control system 102 enables domain-specific controls and handling of communications, as different domains may be associated with different requirements or security constraints.

In some embodiments, the communication evaluation subsystem 116 may determine a domain associated with the query and the output, where the output is incomplete or a partial representation of a full response to the query. As an illustrative example, communication evaluation subsystem 116 may predict a remaining output based on an output from a machine learning model (e.g., an LLM). In some embodiments, communication evaluation subsystem 116 may utilize a heavyweight LLM to generate a portion of the output, in response to the query. In order to conserve computational resources, a lightweight LLM may generate the remaining output. Based on this remaining output (e.g., along with the query and/or the partial representation of the output), communication evaluation subsystem 116 may predict a corresponding domain, thereby enabling generation and classification of a given textual communication or conversation, while preserving computational resources associated with the heavyweight model (e.g., by limiting memory allocations, processor use, or model weight storage or training). In some embodiments, communication evaluation subsystem 116 may predict a domain based on a partial output of the lightweight model and/or the heavyweight model, prior to generation of further output. For example, the breach prevention subsystem 120 may determine to cause termination of further generation of output based on the partial representation of the response upon determination of a potential security breach or security concern (e.g., upon determination of satisfaction of the first or second criteria, as discussed below). As such, communication control system 102 enables evaluation and classification of communications (e.g., as in a chatbot conversation) based on light use of computational resources, while providing the ability to detect security breaches prior to transmission of sensitive information to users.

For example, communication control system 102, through communication subsystem 112, may receive a query relating to account information (e.g., provision of an account number and registration date). Based on a partial or incomplete output from an LLM (e.g., a heavyweight or a lightweight model), communication control system 102 may determine domains likely associated with the associated chatbot conversation, in lieu of generation of a full output in response to the query. For example, the partial output may include a partial account number or an indication that further output may include an account number. As such, communication evaluation subsystem 116 may determine to terminate further generation of the output and/or may determine a domain associated with the conversation, thereby enabling dynamic evaluation of chatbot outputs while conserving system resources.

A confidence indicator may include a metric (e.g., a quantitative measure) or a value (e.g., categorical or quantitative) quantifying a confidence or likelihood. For example, confidence values 406 may include values associated with domains, where the values indicate a likelihood that a given domain corresponds to the textual communication and preliminary output associated with a chatbot conversation. As an illustrative example, communication evaluation subsystem 116 may determine that textual communication 204 and preliminary output 206 of FIG. 2 are more likely to correspond to a conversation associated with account metadata (e.g., Domain B of FIG. 4), rather than user authentication (e.g., Domain A of FIG. 4); communication evaluation subsystem 116 may quantify this determination based on confidence values 406. By doing so, communication evaluation subsystem 116 may determine which rules or controls to apply to the conversation prior to transmission to the user, so as to prevent domain-specific security breaches. Moreover, communication evaluation subsystem 116 enables communication control system 102 to prevent generation of further outputs in situations where the applicable domain is unknown or uncertain, thereby preventing unintended or undesirable outputs from being shown to the user.

In some embodiments, communication evaluation subsystem 116 may generate a communication summary for categorization and domain determination. For example, communication evaluation subsystem 116 may generate a communication summary. In some embodiments, the communication summary includes the first textual communication and the first output. Communication evaluation subsystem 116 may provide the communication summary to a classification model (e.g., classification model 308) to generate a semantic classification. In some embodiments, the semantic classification includes a categorization of semantic content associated with the communication summary. Communication evaluation subsystem 116 may generate the first communication profile to include a first domain. For example, the first domain may correspond to the semantic classification. As an illustrative example, communication evaluation subsystem 116 may utilize a natural language processing algorithm capable of categorizing (e.g., classifying) natural language into classifications that are associated with semantic meaning (e.g., semantic classifications). For example, the classification model may determine that both textual communication 302 and preliminary output 306 include words, phrases, or other semantic information associated with bank account metadata. As such, communication evaluation subsystem 116 may determine one or more domains that are associated with the textual communication and preliminary output based on the semantic information within.

A communication summary may include any summary, description, or representation of communications. For example, a communication summary may include any inputs and outputs associated with users and/or any LLMs. For example, a communication summary may include a vectorized or tokenized form of a chatbot conversation, including both a user's queries or comments, and an LLM's responses (e.g., the preliminary output or another type of output). By generating a semantic classification of the data based on the communication summary, communication evaluation subsystem 116 may consider the conversation as a whole (e.g., including any and all parties to the conversation) in its evaluation of the subject matter or categorization of the conversation, thereby improving the accuracy of determining any controls or restrictions associated with the conversation.

A semantic classification may include classification or categorization of verbal content (e.g., text, speech, or signed language) based on semantics (e.g., meaning). For example, a semantic classification may include an analysis of words, phrases, or sentences within communications for determination of a category associated with the communications. For example, a semantic classification may include a classification that a conversation is associated with “user authentication” based on a frequency of words associated with user authentication. By generating a semantic classification associated with the communications, communication evaluation subsystem 116 enables evaluation of chatbot conversations based on the meaning within these conversations, thereby improving the quality of controls or restrictions imposed on the conversations. By doing so, communication control system 102 enables improved security breach prevention.

In some embodiments, the system may generate confidence metrics associated with these semantic classifications for generation of the confidence indicators. For example, communication evaluation subsystem 116 may generate, using the classification model, a first confidence metric associated with the semantic classification. In some embodiments, the first confidence metric indicates an estimated likelihood that the semantic classification corresponds to a ground-truth semantic classification for the communication summary. Communication evaluation subsystem 116 may generate the first communication profile to include the first confidence metric. As an illustrative example, classification model 308 may generate a value indicating a confidence in the generated semantic classification for the communication summary. For example, this confidence metric can include a likelihood that the conversation indeed is associated with the semantic classification. By generating the confidence metric and including this metric within the communication profile, communication evaluation subsystem 116 enables evaluation of the likely accuracy of a given categorization (e.g., of a given domain), thereby providing data that may inform further handling of the conversation, as discussed below.

In some embodiments, communication evaluation subsystem 116 may determine that the communication profile is consistent with first criteria or second criteria. For example, communication evaluation subsystem 116 may determine, based on the indication of the one or more domains and the one or more confidence indicators, that the first communication profile satisfies first criteria or second criteria. As an illustrative example, communication evaluation subsystem 116 may determine that there is sufficient confidence that the conversation is associated with one or more given domains. For example, communication evaluation subsystem 116 may determine that a communication summary that includes both the user's input query or textual communication, as well as the preliminary output from the lightweight LLM, is consistent with a request for account metadata and, as such, that the chatbot conversation is likely associated with Domain B shown in FIG. 4 and that the conversation satisfies the first criteria. Communication evaluation subsystem 116 may compare a confidence value associated with the domain with a threshold confidence value in order to determine that there is sufficient confidence in the determine domain. As such, in some embodiments, communication evaluation subsystem 116 may determine that the textual communication and preliminary output correspond to a known categorization and, therefore, that further output generation may take place subject to domain-specific controls. By doing so, communication control system 102 enables domain-specific handling of chatbot conversations based on an efficiently generated preliminary output, prior to propagation of any sensitive or undesirable information to the requesting user.

Communication evaluation subsystem 116 may determine that the communication profile satisfies the first criteria based on comparing a confidence value associated with a given domain with a corresponding threshold confidence value associated with the domain. As an illustrative example, a threshold confidence value may be pre-determined, or may depend on the associated domain. For example, in some embodiments, communication evaluation subsystem 116 may determine that the communication profile satisfies the first criteria based on determining that the communication profile indicates that a given confidence value associated with a given domain is higher than confidence values associated with other domains. As such, communication control system 102 enables handling of chatbot conversations or other textual communications on the basis of confidence that the conversation is associated with a given subject area or categorization, thereby ensuring that the conversation is subsequently handled with the appropriate domain-specific controls.

In some embodiments, communication control system 102 may determine rulesets associated with the communications (e.g., the first textual communication and the preliminary output) based on satisfaction of the first criteria. For example, based on the first communication profile corresponding to the one or more domains, communication evaluation subsystem 116 may determine one or more rulesets corresponding to the one or more domains. As an illustrative example, FIG. 4 shows rule identifiers 408 associated with domains determined to be associated with textual communication 302 and preliminary output 306, as well as associated values 410. Rules, as specified by rule identifiers 408, may include identification of controls, restrictions, or frameworks that are associated with given domains. As an illustrative example, a domain corresponding to user authentication (e.g., Domain A shown in FIG. 4) may include rules associated with the credentials needed for this categorization of conversation (e.g., where credentials may include different levels, such as Level 1 or Level 2). In some embodiments, a given domain may include rules associated with whether sensitive or protected information may be disclosed to the user or not, as well as whether there are control tokens (e.g., particular words or phrases) to be filtered or screened out of generated outputs. As such, communication evaluation subsystem 116 enables communication monitoring subsystem 118 to effectively monitor and control generated information according to the domains likely to be associated with the given conversation.

A ruleset may include a set of rules associated with communications. For example, ruleset 412 may relate to a particular domain (e.g., Domain A of FIG. 4), and may include a set of values 410 that describe controls or restrictions associated with a given domain. As an illustrative example, ruleset 412 may include rules, which are indications of such restrictions or controls. For example, rules may include indications of whether various levels of user credentials are required for a conversation associated with user authentication. In some embodiments, the ruleset may indicate whether sensitive information may be disclosed to the user, such as whether sensitive or confidential information generated by an LLM may be transmitted to the user, or whether such information must be filtered out. As shown in FIG. 4, such rules may be domain-dependent; for example, a conversation relating to account metadata may not require high levels of user credential verification, but may be subject to controls on sensitive information disclosure. As such, by enabling domain-specific controls on conversations on the basis of preliminary outputs by lighter-weight LLMs, communication monitoring subsystem 118 enables domain-specific monitoring and controlling of chatbot conversations.

In some embodiments, communication control system 102 may provide the first textual communication to a heavier-weight model to generate a second, validated output, while controlling the conversation according to relevant rulesets or controls. For example, based on the first communication profile satisfying the first criteria, communication control system 102 may provide, according to the one or more rulesets, the first textual communication to the second model to generate, for display on a user interface, a second output. As an illustrative example, communication control system 102 may utilize text generation subsystem 114 (e.g., through heavyweight LLM 314) to generate a second output according to the rules and controls identified by classification model 308. For example, this output may be validated where sensitive information is filtered out or where user credentials are requested prior to further generation of output (e.g., prior to divulging bank details or other sensitive information). By doing so, communication monitoring subsystem 118 may monitor the output according to domain-specific rules or restrictions, thereby preventing security breaches, while providing the user with requested information.

Text generation subsystem 114 may generate a second or validated output. A validated output may include an output subject to filtering, credential validation, or any controls, restrictions, or requirements. In some embodiments, validated output may include a message that requests further information prior to generating any information for the user in response to a user query. For example, as shown in FIG. 2, validated output 208 may include instructions for a user to provide user credentials for further generation of output. In some embodiments, validated output 208 may include an output with certain words, phrases, or sentences filtered out, such as swear words or sensitive information. As such, the system enables generation of validated, secure information for display to a user in a domain-specific manner, thereby preventing security breaches.

In some embodiments, communication control system 102, through communication subsystem 112, may request user credentials based on the rulesets associated with domains. For example, communication control system 102 may determine that a first confidence indicator of the one or more confidence indicators meets a corresponding threshold confidence value associated with a first domain of the one or more domains. Communication control system 102 may obtain user authentication requirements corresponding to the first domain. Communication control system 102 may transmit, to a user device associated with a user, a user credential request indicating the user authentication requirements. Communication control system 102 may receive, from the user device, user credentials for the user. Communication control system 102 may determine that the user credentials satisfy the user authentication requirements. Based on determining that the user credentials satisfy the user authentication requirements, communication control system 102 may generate, for display on the user interface of the user device, the second output. As an illustrative example, communication control system 102 may determine that a domain associated with the textual communication and the preliminary output is such that user authentication is required. For example, communication control system 102 may determine that the conversation is associated with user authentication and, accordingly, request user credentials, such as a username, password, or two-factor authentication. Based on this authentication, communication evaluation subsystem 116 may generate further output, thereby preventing security breaches to unauthorized users.

User authentication requirements may include information relating to user authentication rules, guidelines, or restrictions associated with a given conversation, domain, or communication. A ruleset associated with one or more domains may include user authentication requirements. For example, a user authentication requirement may include an indication of a set of user credentials required to be verified prior to transmission of related outputs to a user. As shown in FIG. 4, a ruleset corresponding to a domain may specify that a domain may be associated with different levels of credentials and, as such, may require different levels of credential verification. For example, user authentication requirements for Domain B of FIG. 4 may specify that a user must provide a username and password (e.g., Level 1 Credentials) to access account metadata information, while two-factor authentication (e.g., Level 2 Credentials) may not be necessary for account metadata. In some embodiments, two-factor authentication may be required for another domain (e.g., Domain A). As such, communication control system 102 enables domain-specific controls and barriers to generated outputs, thereby preventing security breaches to undesirable or unauthenticated entities.

For example, in response to determining that a domain is associated with a user authentication requirement, communication control system 102, through communication subsystem 112, may transmit a request for user credentials (e.g., a user credential request). Such a request may include a message, as in validated output 208 of FIG. 2, requesting further credentials or verification of the user. In some embodiments, a user credential request may include a form that enables a user to provide user credentials, such as a username (or other identifiers, such as an account number, a phone number, or an email address) and a password, or multifactor authentication using an associated device or key. In some embodiments, user credentials may include verification of physical credentials, such as physical identity documents (e.g., passports, driver's licenses, or identification cards), such as through a corresponding online portal. In some embodiments, a user credential request may request proof of a particular status or classification of the user, such as evidence that the user is an administrator of the system or an account holder of a corresponding online bank. As such, communication control system 102 enables domain-specific access controls on information provided by associated chatbots or other NLG algorithms.

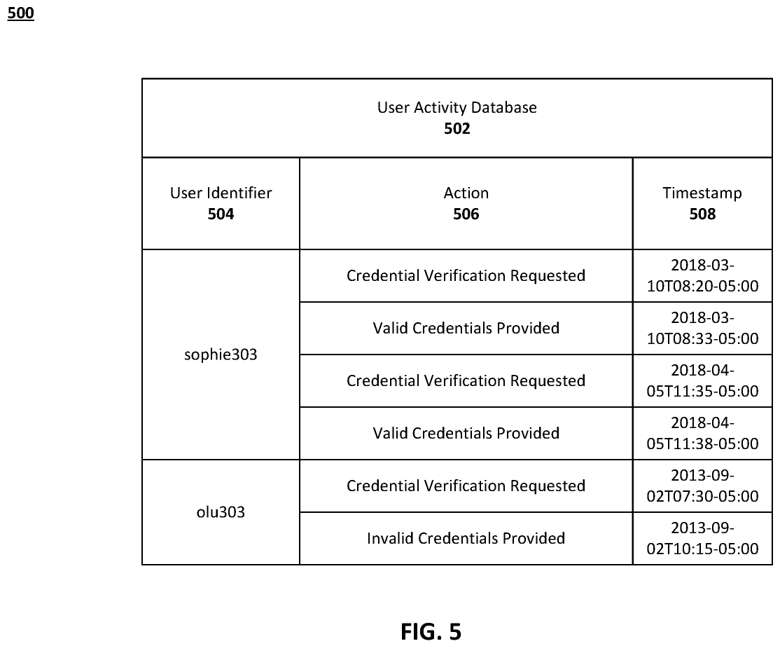

FIG. 5 shows illustrative data structure 500 of user activity database 502, in accordance with one or more embodiments of this disclosure. For example, FIG. 5 depicts user activity for users associated with user identifiers 504, including actions 506 taken by the users, as well as corresponding timestamps 508. For example, user activity database 502 includes information relating to credentials provided by users in the past, as well as when such credentials were provided. As such, user activity database 502 enables evaluation of users for a likelihood of providing valid credentials for authentication prior to accessing any sensitive or confidential information from an LLM, thereby enabling communication control system 102 to prevent security breaches and disclosures of protected information to undesired entities.

In some embodiments, communication control system 102 may determine an authentication probability associated with a user attempting to communicate in a domain with user authentication requirements. Accordingly, communication monitoring subsystem 118 may determine to provide access to the user where the authentication probability is above a threshold probability level. For example, communication control system 102 may determine that a first confidence indicator of the one or more confidence indicators meets a corresponding threshold confidence value associated with a first domain of the one or more domains. Communication control system 102 may obtain user authentication requirements corresponding to the first domain. Communication control system 102 may determine a user identifier corresponding to a user associated with the first textual communication. Communication control system 102 may obtain, from a user activity database, user activity data. In some embodiments, the user activity data includes information relating to previous textual communications and corresponding outputs associated with the user. Communication control system 102 may generate an authentication probability based on the user activity data. In some embodiments, the authentication probability indicates a likelihood that the user provides user credentials that satisfy the user authentication requirements. Communication control system 102 may compare the authentication probability with a threshold authentication probability. Communication control system 102 may determine that the authentication probability meets the threshold authentication probability. In response to determining that the authentication probability meets the threshold authentication probability, communication control system 102 may generate, for display on the user interface, the second output. As an illustrative example, communication control system 102 may obtain a history of user authentication events, including occasions where the user provided valid credentials. In some embodiments, user activity database 502 may include information relating to network paths, internet protocol (IP) addresses, or other information that is relevant to user authentication during such user credential events. In some embodiments, the user activity data within the user activity database may include information relating to previous textual communications associated with the user, such as previous queries or chatbot conversations (including generated outputs) corresponding to the user. Based on this user activity information, communication control system 102 may determine an authentication probability associated with the user and determine to generate the second output based on this information. By doing so, communication control system 102 enables provision of information to users that are likely authorized to access information relating to a given domain, thereby streamlining the imposed domain-specific controls.

A user identifier may include any identification marker, token, or symbol associated with a user. For example, a user identifier may include a username, an email address, an account number (e.g., a bank account number), a contact number, a Social Security number, or any other identifier of a given user of communication control system 102. For example, a user identifier may be associated with a given user during a registration process and may be associated with physical or virtual identification documents or tokens (e.g., through a multifactor authentication token generator). A user identifier enables communication evaluation subsystem 116 to track and evaluate a user's historical behavior with respect to the system for evaluation of the user's likelihood to provide valid credentials associated with a given domain.

A user activity database may include a data structure or collection of information relating to user activities. For example, a user activity database may include information relating to multiple users, where such information includes user activity data associated with a given user. User activity data may include information associated with events or actions of users (e.g., actions 506), including corresponding timestamps 508. For example, user activity data may include indications of a user receiving a credential verification request, and where a user provided valid or invalid credentials in response. In some embodiments, user activity data may include previous communications associated with the user, such as previous queries to an LLM (e.g., an associated chatbot), as well as any generated responses. User activity data may, in some implementations, include communications with human entities. In some embodiments, user activity data may include information relating to a user's trustworthiness, such as a credit score, a credit report, or other such measures.

An authentication probability may include an indication of a likelihood that a user may provide user credentials that satisfy user authentication requirements. For example, an authentication probability may include a probability that a user may provide a valid username and password in response to a request for such information (e.g., if Level 1 Credentials, as in FIG. 4, are requested). For example, communication control system 102 may provide the user activity data corresponding to a given user to a machine learning model, as well as any current user information (e.g., network path information, such as IP addresses or location information associated with the user) to generate a probability that a user may provide valid authentication, given the user's history. In some embodiments, a user may be associated with various authentication probabilities corresponding to different levels of user authentication requirements (e.g., as corresponding to different domains). For example, Domain A of FIG. 4 (e.g., relating to user authentication) may require higher-level credentials from a user, including multifactor authentication in addition to a username and password, which may reflect in a decreased authentication probability for a user that is less likely to provide multifactor authentication based on corresponding user activity data. Communication control system 102 may compare the authentication probabilities generated with a threshold authentication probability prior to determining to provide the second output for display to the user, thereby preventing any unintended disclosure of sensitive information to users who are less likely to provide satisfactory user credentials. By including information relating to previous communications, outputs, and validation events, and by generating corresponding authentication probabilities, communication control system 102 enables evaluation of a user with respect to any user authentication requirements associated with a domain of a chatbot conversation. For example, communication control system 102 enables users that are likely to provide proper user credentials to receive a generated output without further authentication, thereby streamlining controls imposed by communication control system 102 and improving the user's experience.

In some embodiments, communication control system 102 may determine that the authentication probability does not meet the threshold authentication probability and may determine to execute termination protocol prior to completing generation of the second output. For example, communication monitoring subsystem 118 may determine that the authentication probability does not meet the threshold authentication probability. In response to determining that the authentication probability does not meet the threshold authentication probability, communication monitoring subsystem 118 may cause the execution of the termination protocol prior to completing generation of the second output. As an illustrative example, in situations where a user is determined not to be likely to provide valid authentication credentials (e.g., in situations where the user has historically failed to provide valid credentials), a system may determine to execute termination protocol. For example, breach prevention subsystem 120 may generate a termination message, or deny any generation of the complete output in response to the user query, thereby preventing security breaches preemptively.

In some embodiments, communication control system 102, through communication monitoring subsystem 118, may determine whether a user has access to conversations associated with a given domain by obtaining a user permission status associated with the user. For example, communication monitoring subsystem 118 may determine that a first confidence indicator of the one or more confidence indicators meets a corresponding threshold confidence value associated with a first domain of the one or more domains. Communication monitoring subsystem 118 may determine a user identifier corresponding to a user associated with the first textual communication. Communication monitoring subsystem 118 may determine, based on the user identifier, a user permission status for the user. For example, the user permission status indicates user access to outputs corresponding to the first domain. Based on the user permission status, communication monitoring subsystem 118 may generate, for display on the user interface, the second output. As an illustrative example, the system may determine that the user's conversation with a chatbot is associated with Domain B (e.g., account metadata) and, as such, that the user may require permission to access associated generated outputs from the LLM. For example, a user may require registration for a pre-existing bank account in order to access an underlying online banking system. As such, communication control system 102 may obtain information relating to whether the user has such permissions by determining a user permission status (e.g., through a lookup within third-party databases 108a-n). As such, communication control system 102 may determine to display the output to the user if the user is associated with a satisfactory user permission status.

A user permission status may include an indication of whether a user has permission to access data (e.g., data associated with a given domain). For example, domains (e.g., categorizations of chatbot conversations) may be associated with rulesets that specify that only users of particular categories or permissions may have access to LLM outputs associated with such domains. For example, communication monitoring subsystem 118 may determine that a given conversation is associated with user account metadata (e.g., Domain B of FIG. 4) and, therefore, that only registered users may have access to such a conversation. As such, communication monitoring subsystem 118 may determine whether a user has a permission corresponding to a given domain (e.g., corresponding to a ruleset of the given domain). For example, a user permission status may include an indication that the user is indeed a registered user of a banking system and, as such, that the user has access to generated outputs that are associated with account metadata. By doing so, communication control system 102 may impose controls associated with the type of users that may access information generated from LLMs in a domain-specific manner.

In some embodiments, communication monitoring subsystem 118 may detect that output associated with a domain includes tokens that are forbidden within this domain. Based on this detection, communication monitoring subsystem 118 may determine to terminate generation of the output pre-emptively. For example, communication monitoring subsystem 118 may determine, based on the one or more rulesets, a plurality of control tokens. In some embodiments, each control token of the plurality of control tokens indicates a forbidden natural language token. Communication monitoring subsystem 118 may monitor generation of the second output to detect that at least a portion of the second output includes a first token of the plurality of control tokens. Based on detecting that at least the portion of the second output includes the first token, communication monitoring subsystem 118 may cause the execution of the termination protocol prior to completing generation of the second output. As an illustrative example, communication monitoring subsystem 118 may monitor any outputs generated from an LLM (e.g., a lightweight or heavyweight LLM) for any words, tokens, or phrases considered to be undesirable, malicious, or inappropriate. As an example, communication monitoring subsystem 118 may detect a swear word or sensitive information that is forbidden to the user; as such, breach prevention subsystem 120 may terminate generation of the output prior to display to the user upon detecting any control tokens. In some embodiments, such control tokens may be dependent on the domain and corresponding ruleset. For example, a more informal domain (e.g., relating to social media associated with an online bank, for example) may have more relaxed control tokens (e.g., may allow mild swear words in outputs), while a more professional domain (e.g., relating to professional or banking services) may have a greater number of control tokens with stricter output requirements. As such, breach prevention subsystem 120 enables monitoring and prevention of outputs that may be harmful or present security breaches.

A control token may include a word, phrase, sentence, or another natural language token (including numerical values) that may be forbidden or otherwise controlled. For example, a control token may include swear words or data to be prevented from display or transmission to a user. As an illustrative example, a control token may include an indication of a phrase or word that is insensitive or inappropriate, or may include information or data that is sensitive, private, or otherwise protected. By detecting control tokens, communication monitoring subsystem 118 enables breach prevention subsystem 120 to prevent display of such tokens to the user, thereby pre-emptively mitigating any security breaches or improper responses in response to user queries to a chatbot.

In some embodiments, communication control system 102 may determine that the conversation satisfies second criteria (e.g., rather than the first criteria) and determine to execute termination protocols based on the satisfaction of this criteria. For example, based on the first communication profile satisfying the second criteria, breach prevention subsystem 120 may cause execution of a termination protocol in lieu of providing, according to the one or more rulesets, the first textual communication to the second model to generate, for display on the user interface, the second output. As an illustrative example, communication control system 102 may determine that one or more confidence indicators (e.g., confidence values) associated with one or more domains do not meet corresponding threshold confidence values. Communication evaluation subsystem 116 may have insufficient confidence in a domain or categorization associated with the conversation (e.g., the first textual communication and preliminary output). For example, a user may provide a query that is irrelevant or previously unknown to communication control system 102. In some embodiments, the preliminary output may include information that is not pertinent to the user's request, or includes inaccurate or sensitive information, thereby leading to a low confidence value. As such, breach prevention subsystem 120 may determine to terminate further communications, such as by preventing generation of a complete output by a heavier-weight LLM. By doing so, communication control system 102 enables security breach mitigation by terminating further generation of outputs prior to disclosure to the user, as an example.

A termination protocol may include an algorithm, method, or process associated with termination of a program, such as termination of NLG. For example, a termination protocol may include changing a state of an LLM such that further generation of output from an LLM (e.g., heavyweight or lightweight) is interrupted or prevented. In some embodiments, the termination protocol may include generation of a message indicating an end to further generated outputs, as discussed below. In some embodiments, the termination protocol may prevent any generation of output by a specified model. For example, the termination protocol may enable a lightweight LLM to continue generation of a preliminary output, while preventing any generation of an output for display to a user by a heavyweight LLM. The termination protocol may disable any chatbot-related features associated with bank accounts and may refer a user to a human or another site for further assistance. As such, a termination protocol enables breach prevention subsystem 120 to prevent security breaches by preventing disclosure of any undesired information to the user based on a preliminary output by a lighter-weight model. Thus, communication control system 102 enables controls based on detecting (or failing to detect) domains associated with the chatbot conversations.

In some embodiments, executing the termination protocol may include generation of a termination message for display on a user interface associated with the user. For example, breach prevention subsystem 120 may generate a termination message. In some embodiments, the termination message includes an indication of the one or more confidence indicators. Communication subsystem 112 may generate, for display on the user interface, the termination message. As an illustrative example, communication subsystem 112 may generate a message (e.g., a termination message or a communication termination message) to the user indicating that further communications are prohibited. In some embodiments, communication subsystem 112 may generate the message to include an indication that an associated chatbot or LLM may be reset, enabling the user to re-enter a new query that is within a set of specified guidelines. In some embodiments, the termination message may include an indication of confidence indicators, such as an indication that a domain associated with the conversation could not be determined to a particular confidence level. In some embodiments, the communication termination message may include a list of domains and associated confidence intervals, thereby enabling the user to select a domain prior to reinitiation of the chatbot with the set of rules associated with the chosen domain. As such, by generating a communication termination message to the user, communication control system 102 enables users to obtain information relating to why a particular user query is not appropriate or is likely to cause a security breach, thereby enabling the user to correct the issue or seek assistance elsewhere.

In some embodiments, executing the termination protocol may include transmitting metadata associated with the communication to an administrator for further handling or determination of domains and associated rulesets. For example, breach prevention subsystem 120 may generate communication metadata. In some embodiments, the communication metadata includes at least a portion of the first textual communication, at least a portion of the first output, a timestamp, and a user identifier of a user associated with the first textual communication. Communication evaluation subsystem 116 may generate, based on the communication metadata, a candidate ruleset. Communication subsystem 112 may transmit, to an administrator system, the candidate ruleset. Communication subsystem 112 may obtain from the administrator system, a first ruleset associated with a first domain. Communication evaluation subsystem 116 may generate the one or more rulesets to include the first ruleset. As an illustrative example, communication control system 102 may compile information relating to the user's input (e.g., the first textual communication) and the preliminary output from the lightweight LLM (e.g., the first output), as well as information relating to the interaction (e.g., identification of the user generating the query) in order to generate communication metadata. Communication evaluation subsystem 116 may determine a candidate ruleset that may be most likely to be associated with the communications (e.g., based on determining a domain of a plurality of domains with the greatest confidence value of a corresponding plurality of confidence values). Communication subsystem 112 may transmit this candidate ruleset to an administrator system (e.g., a user associated with administrator duties) for confirmation of the ruleset associated with the given communication. For example, the administrator system may modify the candidate ruleset and transmit this modified ruleset to communication control system 102 for further generation of the output according to these rules. As such, communication control system 102 enables administrator systems to provide further guidance, controls, and restrictions on conversations for which domains could not be determined with accuracy, thereby enabling dynamic handling of new or ambiguous chatbot conversations.

For example, communication metadata may include information relating to communications. For example, communication metadata may include at least a portion of a user's query (e.g., the first textual communication), at least a portion of a model's output (e.g., the preliminary output or the validated output), a timestamp, and a user identifier of a user associated with the user query. An administrator system may determine or generate a domain associated with the communication metadata and generate a ruleset based on this domain. For example, an administrator system may include a system or entity responsible for maintenance, upkeep, management, performance, or operation of a system, such as communication control system 102. In some embodiments, an administrator system may include an administrator associated with an online banking system. As such, the communication metadata may include contextual information relating to the user's query, thereby enabling an administrator system to evaluate the communication for determination of any required controls.

In some embodiments, communication control system 102, through communication monitoring subsystem 118, may dynamically monitor the second output (e.g., the validated output) for adherence with the rulesets associated with the conversation's domain. For example, communication monitoring subsystem 118 may determine a plurality of rulesets corresponding to the plurality of domains. Communication monitoring subsystem 118 may monitor generation of the second output to detect that at least a portion of the second output satisfies a first rule of a first ruleset corresponding to the one or more domains. Based on detecting that at least the portion of the second output satisfies the first rule, communication monitoring subsystem 118 may cause the execution of the termination protocol prior to completing generation of the second output. As an illustrative example, communication monitoring subsystem 118 may determine whether the second output is consistent with any rules or restrictions imposed by an associated ruleset. For example, communication monitoring subsystem 118 may ensure that the generated output does not include sensitive information, as specified by a ruleset associated with account metadata-related domains. In some embodiments, communication monitoring subsystem 118 may determine whether any forbidden tokens (e.g., control tokens, such as swear words) are generated by the heavyweight LLM and interrupt the generation of the second output accordingly. As such, communication monitoring subsystem 118 enables dynamic monitoring to mitigate security breaches or undesirable outputs in a domain-specific manner.

In some embodiments, communication monitoring subsystem 118 may generate a cache record based on rules associated with the conversation for efficient monitoring of the conversation for satisfaction of the rules. For example, communication monitoring subsystem 118 may generate a cache record. In some embodiments, the cache record includes the first textual communication, first rule of the first ruleset, and at least the portion of the second output. Communication monitoring subsystem 118 may store the cache record in a user cache associated with a user device. Communication monitoring subsystem 118 may receive a second textual communication. Communication monitoring subsystem 118 may determine, based on the user cache, that the second textual communication relates to at least a portion of the first textual communication. Based on determining that the second textual communication relates to at least the portion of the first textual communication, communication monitoring subsystem 118 may cause the execution of the termination protocol. As an illustrative example, communication monitoring subsystem 118 may generate a summary of rules associated with a particular conversation; thus, upon receiving another query from the user, communication monitoring subsystem 118 may determine that this second query is associated with the user's first query (e.g., the first textual communication) and preload the corresponding rules accordingly. As such, communication monitoring subsystem 118 enables efficient detection and management of controls associated with chatbot conversations dynamically.

A cache record may include a record or summary of information. For example, a cache record may include a record of the first textual conversation (e.g., a user's first query within a chatbot associated with a banking system), as well as associated domains (e.g., an indication that the query is associated with bank account metadata), and a portion of the output (e.g., the validated output from the model). For example, a cache record may include a duplication of data such that this data associated with the conversation may be more efficiently accessed, thereby improving the speed with which the conversation may be monitored according to the corresponding rulesets (e.g., to detect whether sensitive information is being disclosed contrary to the corresponding domain's rules). Communication monitoring subsystem 118 may access this information within a pre-defined cache, which may include a data structure (e.g., a hardware or a software component) associated with communication control system 102.

In some embodiments, communication monitoring subsystem 118 may determine that the generated output is associated with a third model and may cause generation of a third output accordingly. For example, communication control system 102 may determine a plurality of rulesets corresponding to the plurality of domains. Communication monitoring subsystem 118 may monitor generation of the second output to detect that at least a portion of the second output satisfies a first rule of a first ruleset corresponding to the one or more domains and that at least the portion of the second output does not satisfy a second rule of a second ruleset corresponding to the one or more domains. In some embodiments, the first ruleset is associated with a first domain of the plurality of domains and the second ruleset is associated with a second domain of the plurality of domains. Based on detecting that at least the portion of the second output satisfies the first rule and that at least the portion of the second output does not satisfy the second rule, text generation subsystem 114 may provide the first textual communication to a third model associated with the second domain to generate, for display on the user interface, a third output, the third model including a third resource size. The third resource size may be greater than the first resource size. As an illustrative example, communication control system 102 may determine that another chatbot is better configured to answer questions relating to the user's query—for example, a banking system may include another chatbot that is configured to answer account management questions, while the chatbot associated with the second model (e.g., the heavyweight model) is configured to assist with user authentication queries. Thus, the system may determine that a first domain associated with the communication profile is not consistent with the user's query and corresponding output, while a second domain associated with the communication profile is indeed consistent, based on satisfaction of the rules within the corresponding rulesets. As such, communication control system 102 enables forwarding of the user's queries to another chatbot or model for satisfactory resolution of the user's queries based on detection or tuning of the domain of the conversation.

In some embodiments, communication monitoring subsystem 118 may detect a change in a domain associated with the communications based on new inputs (e.g., other received textual communications) and monitor these communications accordingly. For example, communication subsystem 112 may receive a second textual communication. Text generation subsystem 114 may provide the second textual communication to the first model to generate a third output. Communication evaluation subsystem 116 may generate, based on the second textual communication and the second output, a second communication profile. The second communication profile may include a first domain. Communication evaluation subsystem 116 may determine that the second communication profile satisfies the first criteria. Based on determining that the second communication profile satisfies the first criteria, communication evaluation subsystem 116 may determine that the first domain does not correspond to the one or more domains. Based on determining that the first domain does not correspond to the one or more domains, communication evaluation subsystem 116 may provide, according to a first ruleset associated with the first domain, the second textual communication to the second model to generate a fourth output. As an illustrative example, as a chatbot conversation with an online banking center progresses, a user may request information that is unrelated to the original query (e.g., user credential information, rather than account metadata). Based on detecting such a change (through generation of a corresponding communication profile), communication monitoring subsystem 118 may determine to generate an output associated with the updated domain. As such, communication monitoring subsystem 118 may dynamically monitor chatbot conversations to prevent security breaches or undesired behavior, even in situations where the nature of the chatbot conversation may change over time.

In some embodiments, communication monitoring subsystem 118 may filter the output of the LLM model to remove any forbidden words, phrases or sentences. For example, communication evaluation subsystem 116 may determine that the first output includes a control token. The control token may include a prohibited word, phrase, or sentence. Communication monitoring subsystem 118 may monitor generation of the second output to detect that at least a portion of the second output includes the control token. Based on detecting that at least the portion of the second output includes the control token, text generation subsystem 114 may generate, for display on the user interface, a modified second output. The modified second output may not include the control token. As an illustrative example, communication monitoring subsystem 118 may monitor an output (e.g., a response of a chatbot associated with an online banking system) to ensure that no forbidden phrases, such as swear words or offensive sentences, are produced. Upon detecting such a control token, breach prevention subsystem 120 may filter the output to remove these sentences, thereby providing a modified output to the user. By doing so, communication control system 102 enables dynamic filtering and monitoring of chatbot conversations in a domain-specific manner.

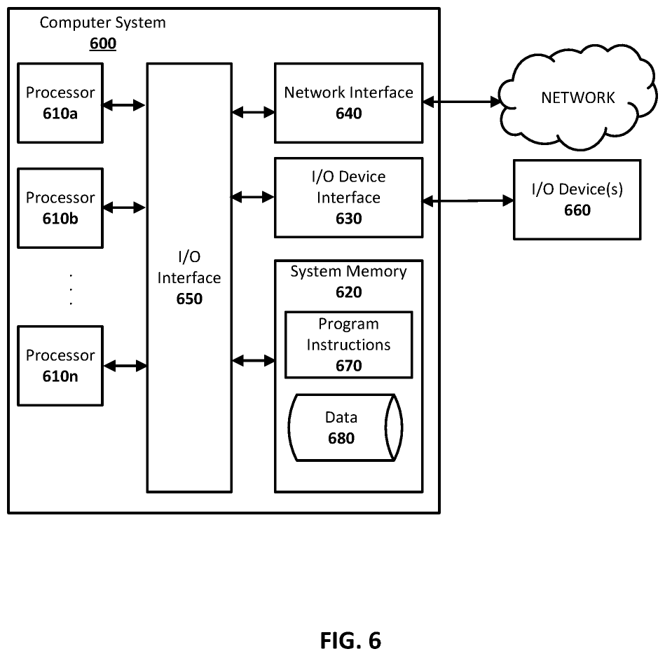

FIG. 6 shows an example computing system that may be used in accordance with some embodiments of this disclosure. In some instances, computing system 600 is referred to as a computer system 600. A person skilled in the art would understand that those terms may be used interchangeably. The components of FIG. 6 may be used to perform some or all operations or generate, transmit, or handle all data discussed in relation to FIGS. 1-5. Furthermore, various portions of the systems and methods described herein may include or be executed on one or more computer systems similar to computing system 600. Further, processes and modules described herein may be executed by one or more processing systems similar to that of computing system 600.

Computing system 600 may include one or more processors (e.g., processors 610a-610n) coupled to system memory 620, an input/output (I/O) device interface 630, and a network interface 640 via an I/O interface 650. A processor may include a single processor, or a plurality of processors (e.g., distributed processors). A processor may be any suitable processor capable of executing or otherwise performing instructions. A processor may include a central processing unit (CPU) that carries out program instructions to perform the arithmetical, logical, and I/O operations of computing system 600. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 620). Computing system 600 may be a uniprocessor system including one processor (e.g., processor 610a), or a multiprocessor system including any number of suitable processors (e.g., processors 610a-610n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus may also be implemented as, special purpose logic circuitry, for example, an FPGA (field-programmable gate array) or an ASIC (application-specific integrated circuit). Computing system 600 may include a plurality of computing devices (e.g., distributed computer systems) to implement various processing functions.

I/O device interface 630 may provide an interface for connection of one or more I/O devices 660 to computer system 600. I/O devices may include devices that receive input (e.g., from a user) or output information (e.g., to a user). I/O devices 660 may include, for example, a graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 660 may be connected to computer system 600 through a wired or wireless connection. I/O devices 660 may be connected to computer system 600 from a remote location. I/O devices 660 located on remote computer systems, for example, may be connected to computer system 600 via network interface 640.

Network interface 640 may include a network adapter that provides for connection of computer system 600 to a network. Network interface 640 may facilitate data exchange between computer system 600 and other devices connected to the network. Network interface 640 may support wired or wireless communication. The network may include an electronic communication network, such as the internet, a local area network (LAN), a wide area network (WAN), a cellular communications network, or the like.

System memory 620 may be configured to store program instructions 670 or data 680. Program instructions 670 may be executable by a processor (e.g., one or more of processors 610a-610n) to implement one or more embodiments of the present techniques. Program instructions 670 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program may be deployed to be executed on one or more computer processors located locally at one site or distributed across multiple remote sites and interconnected by a communication network.

System memory 620 may include a tangible program carrier having program instructions stored thereon. A tangible program carrier may include a non-transitory, computer-readable storage medium. A non-transitory, computer-readable storage medium may include a machine-readable storage device, a machine-readable storage substrate, a memory device, or any combination thereof. A non-transitory, computer-readable storage medium may include non-volatile memory (e.g., flash memory, read-only memory (ROM), programmable ROM (PROM), erasable PROM (EPROM), or electrically EPROM (EEPROM)), volatile memory (e.g., random access memory (RAM), static random-access memory (SRAM), synchronous dynamic RAM (SDRAM)), bulk storage memory (e.g., CD-ROM and/or DVD-ROM, hard drives), or the like. System memory 620 may include a non-transitory, computer-readable storage medium that may have program instructions stored thereon that are executable by a computer processor (e.g., one or more of processors 610a-610n) to cause the subject matter and the functional operations described herein. A memory (e.g., system memory 620) may include a single memory device and/or a plurality of memory devices (e.g., distributed memory devices).

I/O interface 650 may be configured to coordinate I/O traffic between processors 610a-610n, system memory 620, network interface 640, I/O devices 660, and/or other peripheral devices. I/O interface 650 may perform protocol, timing, or other data transformations to convert data signals from one component (e.g., system memory 620) into a format suitable for use by another component (e.g., processors 610a-610n). I/O interface 650 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 600, or multiple computer systems 600 configured to host different portions or instances of embodiments. Multiple computer systems 600 may provide for parallel or sequential processing/execution of one or more portions of the techniques described herein.

Those skilled in the art will appreciate that computer system 600 is merely illustrative and is not intended to limit the scope of the techniques described herein. Computer system 600 may include any combination of devices or software that may perform or otherwise provide for the performance of the techniques described herein. For example, computer system 600 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, a global positioning system (GPS), or the like. Computer system 600 may also be connected to other devices that are not illustrated or may operate as a stand-alone system. In addition, the functionality provided by the illustrated components may, in some embodiments, be combined in fewer components, or distributed in additional components. Similarly, in some embodiments, the functionality of some of the illustrated components may not be provided, or other additional functionality may be available.

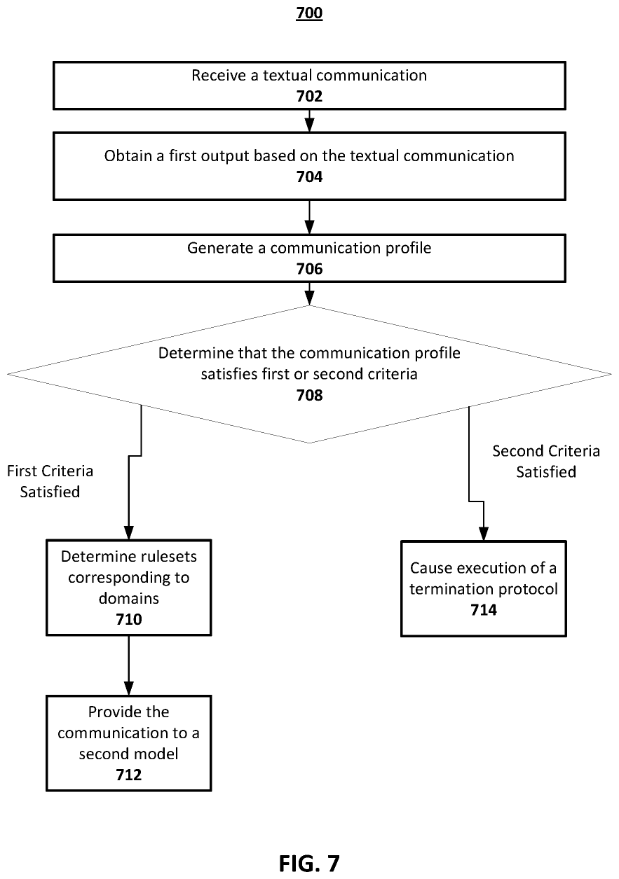

FIG. 7 shows a flowchart of the operations involved in executing domain-specific controls on model-generated outputs, in accordance with one or more embodiments of this disclosure. For example, process 700 enables computer system 600 to monitor chatbot conversations associated with users and impose domain-specific controls or restrictions accordingly, in order to prevent security breaches.

At 702, communication control system 102 (using one or more components described above) enables computer system 600 to receive a textual communication. For example, computer system 600 may receive a first textual communication through network interface 640 and store this textual communication within system memory 620 through I/O interface 650. For example, computer system 600 may store the textual communication as data 680. As an illustrative example, communication control system 102 may receive a query from a customer of an online banking system, where the query includes a request for account-related information (e.g., an account number, a date of registration, or an account balance). By receiving such a query, communication control system 102 may handle the request through generation of a corresponding response using natural language processing, while maintaining any controls or restrictions on the content generated, in order to prevent security breaches (e.g., disclosure of inappropriate or sensitive information to the wrong customers).

At 704, communication control system 102 (using one or more components described above) enables computer system 600 to obtain, via a first model, an output based on the first textual communication. For example, computer system 600 may provide the first textual communication to a first model (e.g., with model parameters stored in system memory 620, and with an algorithm defined within program instructions 670). Computer system 600 may provide the first textual communication to the first model to generate a first output, which may be stored within system memory 620 as data 680. In some embodiments, the first model includes a first resource size, where the first resource size is less than a second resource size associated with a second model (e.g., with parameters stored within system memory 620). For example, computer system 600 may utilize processors 610a-n for generation of the first output. As an illustrative example, communication control system 102 may provide the user's query (e.g., a chatbot message) to a lightweight LLM with relatively few model weights to generate an efficient estimate of the response (e.g., a message indicating the user's requested bank account information) that is likely to be generated in response to the user's query. By doing so, computer system 600 enables accurate, efficient evaluation of the output of the natural language model for determination of the domain (e.g., a category) of the chatbot conversation, as well as for monitoring of any possible security breaches as a result of the generated response.

At 706, communication control system 102 (using one or more components described above) enables computer system 600 to generate a communication profile. For example, computer system 600 may utilize processors 610a-n to generate, based on the first textual communication and the first output, a first communication profile, which may be stored within system memory 620 utilizing I/O interface 650. In some embodiments, the first communication profile includes an indication of one or more domains of a plurality of domains for the first textual communication and one or more confidence indicators. In some embodiments, each confidence indicator of the one or more confidence indicators corresponds to an associated domain of the one or more domains. As an illustrative example, communication control system 102 may generate a summary or profile of the conversation, including subject matter or a theme associated with the conversation. For example, the conversation profile may include a representation of the user's query (e.g., request for bank account information), as well as the preliminary output generated by the lightweight LLM (e.g., a response that includes account information relating to the user). By doing so, communication control system 102 may classify or categorize the conversation for determination of any required controls that may apply to the conversation (e.g., to determine if there are any restrictions on the data that may be provided to the customer in response to the customer's query).

At 708, communication control system 102 (using one or more components described above) enables computer system 600 to determine that the communication profile satisfies first or second criteria. For example, computer system 600 may utilize program instructions 670 to determine, based on the indication of the one or more domains and the one or more confidence indicators, that the first communication profile satisfies first criteria or second criteria (e.g., using program instructions 670). Computer system 600 may store this determination within system memory 620, where the criteria may be stored. As an illustrative example, communication control system 102 may determine that there is confidence in the categorization associated with the conversation. The chatbot conversation, for example, may be determined to be associated with a request for account metadata based on the customer's query, as well as the preliminary response from the lightweight LLM. In some embodiments, communication control system 102 may determine that there is insufficient confidence in the categorization (e.g., the domain) associated with the conversation, in which case breach prevention subsystem 120 may take preventative actions to reduce the chance of security breaches.

At 710, communication control system 102 (using one or more components described above) enables computer system 600 to, based on determining that the communication profile satisfies the first criteria, determine rulesets corresponding to domains. For example, computer system 600 may obtain or determine one or more rulesets corresponding to the one or more domains (e.g., through querying third-party databases 108a-n through network interface 640). Computer system 600 may store these rulesets within system memory 620, such as within data 680. For example, based on a determined domain for the conversation, communication control system 102 may obtain or extract rulesets associated with this domain. For example, communication control system 102 may determine that conversations associated with account metadata for a bank account may require a single level of credential authorization (e.g., provision of a username and a password by the requesting customer). As such, communication control system 102 enables domain-specific controls and restrictions for the conversation, improving the flexibility with which communication control system 102 may prevent security breaches or unauthorized access to the system.

At 712, communication control system 102 (using one or more components described above) enables computer system 600 to, based on determining that the communication profile satisfies the first criteria, provide the communication to a second model. For example, computer system 600 may provide, according to the one or more rulesets, the first textual communication to the second model to generate, for display on a user interface, a second output (e.g., using an I/O device interface 630 for display of the generated output on I/O device(s) 660). For example, computer system 600 may utilize program instructions 670 to run the second model, with parameters stored within data 680. As an illustrative example, communication control system 102, through communication monitoring subsystem 118, may enable generation of a response to the customer's query regarding account data. For example, communication control system 102 may determine that the customer's query within the chatbot conversation is regarding account metadata, and may provide this metadata to the user, subject to any constraints or requirements specified by the associated ruleset (e.g., subject to a requirement to log in with a valid username and password). As such, communication control system 102 enables domain-specific imposition of controls on LLM-generated content, including chatbot conversations, thereby preventing security breaches in a flexible, targeted manner.

At 714, communication control system 102 (using one or more components described above) enables computer system 600 to, based on determining that the communication profile satisfies the second criteria, cause execution of a termination protocol. For example, computer system 600 may, based on the first communication profile satisfying the second criteria, cause execution of a termination protocol (e.g., using program instructions 670) in lieu of providing, according to the one or more rulesets, the first textual communication to the second model to generate, for display on the user interface, the second output. As an illustrative example, communication control system 102 may prevent further generation of outputs for display to the customer, instead redirecting the customer to a human agent or to another appropriate chatbot. In some embodiments, executing the termination protocol may involve requesting further authorization or authentication, including physical or virtual authentication tokens (e.g., physical identifiers, passwords or usernames). For example, communication control system 102 may generate a termination message to a customer indicating that the customer's query is invalid and that a new query should be entered. By doing so, communication control system 102 may prevent unauthorized access to system data by preventing outputs in situations of low confidence, thereby improving the breach mitigation capabilities of communication control system 102.

It is contemplated that the operations or descriptions of FIG. 7 may be used with any other embodiment of this disclosure. In addition, the operations and descriptions described in relation to FIG. 7 may be done in alternative orders or in parallel to further the purposes of this disclosure. For example, each of these operations may be performed in any order, in parallel, or simultaneously to reduce lag or increase the speed of the system or method. Furthermore, it should be noted that any of the components, devices, or equipment discussed in relation to the figures above could be used to perform one or more of the operations in FIG. 7.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

1. A method comprising receiving, from a user device, a textual communication, wherein the textual communication comprises a query for natural language generation, providing the textual communication to a lightweight LLM to generate a preliminary output, wherein the lightweight LLM comprises a first number of model weights, and wherein the first number of model weights is less than a second number of model weights associated with a heavyweight LLM, generating, based on the textual communication and the preliminary output, a communication profile, wherein the communication profile includes an indication of a domain for the textual communication and a corresponding confidence value, and wherein the domain indicates a categorization of a conversation comprising the textual communication and the preliminary output, comparing the corresponding confidence value with a corresponding threshold confidence value associated with the domain, in response to determining that the corresponding confidence value meets the corresponding threshold confidence value associated with the domain: determining a ruleset associated with the domain, providing, according to the ruleset, the textual communication to the heavyweight LLM to generate a validated output for display on the user device, and, in response to determining that the corresponding confidence value does not meet the corresponding threshold confidence value associated with the domain, generating, for display on the user device, a communication termination message in lieu of providing, according to the ruleset, the textual communication to the heavyweight LLM to generate the validated output for display on the user device.
2. A method comprising receiving a first textual communication, providing the first textual communication to a first model to generate a first output, wherein the first model comprises a first resource size, and wherein the first resource size is less than a second resource size associated with a second model, generating, based on the first textual communication and the first output, a first communication profile, wherein the first communication profile includes an indication of one or more domains of a plurality of domains for the first textual communication and one or more confidence indicators, wherein each confidence indicator of the one or more confidence indicators corresponds to an associated domain of the one or more domains, determining, based on the indication of the one or more domains and the one or more confidence indicators, that the first communication profile satisfies first criteria or second criteria, based on the first communication profile satisfying the first criteria, determining one or more rulesets corresponding to the one or more domains, and providing, according to the one or more rulesets, the first textual communication to the second model to generate, for display on a user interface, a second output, and, based on the first communication profile satisfying the second criteria, causing execution of a termination protocol in lieu of providing, according to the one or more rulesets, the first textual communication to the second model to generate, for display on the user interface, the second output.
3. A method comprising receiving a first textual communication, obtaining, via a first model, a first output based on the first textual communication, generating, based on the first textual communication and the first output, a first communication profile, wherein the first communication profile includes an indication of one or more domains of a plurality of domains for the first textual communication and one or more confidence metrics, wherein each confidence indicator of the one or more confidence metrics corresponds to an associated domain of the one or more domains, determining, based on the indication of the one or more domains and the one or more confidence metrics, that the first communication profile satisfies first criteria or second criteria, based on the first communication profile satisfying the first criteria: determining one or more rulesets corresponding to the one or more domains, and obtaining, via a second model according to the one or more rulesets, a second output based on the first textual communication, and, based on the first communication profile satisfying the second criteria, causing execution of a termination protocol in lieu of providing, according to the one or more rulesets, the first textual communication to the second model to generate the second output.
4. The method of any one of the preceding embodiments, further comprising determining a plurality of rulesets corresponding to the plurality of domains, monitoring generation of the second output to detect that at least a portion of the second output satisfies a first rule of a first ruleset corresponding to the one or more domains, and, based on detecting that at least the portion of the second output satisfies the first rule, causing the execution of the termination protocol prior to completing generation of the second output.
5. The method of any one of the preceding embodiments, further comprising generating a cache record, wherein the cache record comprises the first textual communication, first rule of the first ruleset, and at least the portion of the second output, storing the cache record in a user cache associated with a user device, receiving a second textual communication, determining, based on the user cache, that the second textual communication relates to at least a portion of the first textual communication, and, based on determining that the second textual communication relates to at least the portion of the first textual communication, causing the execution of the termination protocol.
6. The method of any one of the preceding embodiments, further comprising determining a plurality of rulesets corresponding to the plurality of domains, monitoring generation of the second output to detect that at least a portion of the second output satisfies a first rule of a first ruleset corresponding to the one or more domains and that at least the portion of the second output does not satisfy a second rule of a second ruleset corresponding to the one or more domains, wherein the first ruleset is associated with a first domain of the plurality of domains and the second ruleset is associated with a second domain of the plurality of domains, and, based on detecting that at least the portion of the second output satisfies the first rule and that at least the portion of the second output does not satisfy the second rule, providing the first textual communication to a third model associated with the second domain to generate, for display on the user interface, a third output, the third model comprising a third resource size, wherein the third resource size is greater than the first resource size.
7. The method of any one of the preceding embodiments, wherein providing the first textual communication to the second model to generate the second output comprises determining that a first confidence indicator of the one or more confidence indicators meets a corresponding threshold confidence value associated with a first domain of the one or more domains, obtaining user authentication requirements corresponding to the first domain, transmitting, to a user device associated with a user, a user credential request indicating the user authentication requirements; receiving, from the user device, user credentials for the user, determining that the user credentials satisfy the user authentication requirements, and, based on determining that the user credentials satisfy the user authentication requirements, generating, for display on the user interface of the user device, the second output.
8. The method of any one of the preceding embodiments, wherein providing the first textual communication to the second model to generate the second output comprises, determining that a first confidence indicator of the one or more confidence indicators meets a corresponding threshold confidence value associated with a first domain of the one or more domains, obtaining user authentication requirements corresponding to the first domain, determining a user identifier corresponding to a user associated with the first textual communication, obtaining, from a user activity database, user activity data, wherein the user activity data comprises information relating to previous textual communications and corresponding outputs associated with the user, generating an authentication probability based on the user activity data, wherein the authentication probability indicates a likelihood that the user provides user credentials that satisfy the user authentication requirements, comparing the authentication probability with a threshold authentication probability, determining that the authentication probability meets the threshold authentication probability, and in response to determining that the authentication probability meets the threshold authentication probability, generating, for display on the user interface, the second output.
9. The method of any one of the preceding embodiments, further comprising determining that the authentication probability does not meet the threshold authentication probability, in response to determining that the authentication probability does not meet the threshold authentication probability, causing the execution of the termination protocol prior to completing generation of the second output.
10. The method of any one of the preceding embodiments, wherein providing the first textual communication to the second model to generate the second output comprises determining that a first confidence indicator of the one or more confidence indicators meets a corresponding threshold confidence value associated with a first domain of the one or more domains, determining a user identifier corresponding to a user associated with the first textual communication, determining, based on the user identifier, a user permission status for the user, wherein the user permission status indicates user access to outputs corresponding to the first domain, and, based on the user permission status, generating, for display on the user interface, the second output.
11. The method of any one of the preceding embodiments, wherein providing, according to the one or more rulesets, the first textual communication to the second model comprises determining, based on the one or more rulesets, a plurality of control tokens, wherein each control token of the plurality of control tokens indicates a forbidden natural language token, monitoring generation of the second output to detect that at least a portion of the second output includes a first token of the plurality of control tokens, and, based on detecting that at least the portion of the second output includes the first token, causing the execution of the termination protocol prior to completing generation of the second output.
12. The method of any one of the preceding embodiments, wherein causing the execution of the termination protocol comprises generating a termination message, wherein the termination message comprises an indication of the one or more confidence indicators, and generating, for display on the user interface, the termination message.
13. The method of any one of the preceding embodiments, wherein causing the execution of the termination protocol comprises generating communication metadata, wherein the communication metadata comprises at least a portion of the first textual communication, at least a portion of the first output, a timestamp, and a user identifier of a user associated with the first textual communication, generating, based on the communication metadata, a candidate ruleset, transmitting, to an administrator system, the candidate ruleset, obtaining, from the administrator system, a first ruleset associated with a first domain, and generating the one or more rulesets to include the first ruleset.
14. The method of any one of the preceding embodiments, wherein generating the first communication profile comprises generating a communication summary, wherein the communication summary comprises the first textual communication and the first output, providing the communication summary to a classification model to generate a semantic classification, wherein the semantic classification comprises a categorization of semantic content associated with the communication summary, and generating the first communication profile to include a first domain, wherein the first domain corresponds to the semantic classification.
15. The method of any one of the preceding embodiments, further comprising generating, using the classification model, a first confidence metric associated with the semantic classification, wherein the first confidence metric indicates an estimated likelihood that the semantic classification corresponds to a ground-truth semantic classification for the communication summary, and generating the first communication profile to include the first confidence metric.
16. The method of any one of the preceding embodiments, further comprising receiving a second textual communication, providing the second textual communication to the first model to generate a third output, generating, based on the second textual communication and the second output, a second communication profile, wherein the second communication profile comprises a first domain, determining that the second communication profile satisfies the first criteria, based on determining that the second communication profile satisfies the first criteria, determining that the first domain does not correspond to the one or more domains, and, based on determining that the first domain does not correspond to the one or more domains, providing, according to a first ruleset associated with the first domain, the second textual communication to the second model to generate a fourth output.
17. The method of any one of the preceding embodiments, wherein providing the first textual communication to the second model to generate the second output comprises determining that the first output includes a control token, wherein the control token includes a prohibited word, phrase, or sentence, monitoring generation of the second output to detect that at least a portion of the second output includes the control token, and, based on detecting that at least the portion of the second output includes the control token, generating, for display on the user interface, a modified second output, wherein the modified second output does not include the control token.
18. One or more tangible, non-transitory, computer-readable media storing instructions that, when executed by a data processing apparatus, cause the data processing apparatus to perform operations comprising those of any of embodiments 1-17.
19. A system comprising one or more processors, and memory storing instructions that, when executed by the processors, cause the processors to effectuate operations comprising those of any of embodiments 1-17.
20. A system comprising means for performing any of embodiments 1-17.

What is claimed is:

1. A system for preventing security breaches due to natural language generation from a heavyweight large language model (LLM) based on an analysis of output data from a lightweight LLM, the system comprising:
one or more processors; and
one or more non-transitory, computer-readable media storing instructions that, when executed by the one or more processors, cause operations comprising:
receiving, from a user device, a textual communication, wherein the textual communication comprises a query for natural language generation;
providing the textual communication to a lightweight LLM to generate a preliminary output, wherein the lightweight LLM comprises a first number of model weights, and wherein the first number of model weights is less than a second number of model weights associated with a heavyweight LLM;
generating, based on the textual communication and the preliminary output, a communication profile, wherein the communication profile includes an indication of a domain for the textual communication and a corresponding confidence value, and wherein the domain indicates a categorization of a conversation comprising the textual communication and the preliminary output;
comparing the corresponding confidence value with a corresponding threshold confidence value associated with the domain;
in response to determining that the corresponding confidence value meets the corresponding threshold confidence value associated with the domain:
determining a ruleset associated with the domain; and
providing, according to the ruleset, the textual communication to the heavyweight LLM to generate a validated output for display on the user device; and
in response to determining that the corresponding confidence value does not meet the corresponding threshold confidence value associated with the domain, generating, for display on the user device, a communication termination message in lieu of providing, according to the ruleset, the textual communication to the heavyweight LLM to generate the validated output for display on the user device.

2. A method comprising:
receiving a first textual communication;
providing the first textual communication to a first model to generate a first output, wherein the first model comprises a first resource size, and wherein the first resource size is less than a second resource size associated with a second model;
generating, based on the first textual communication and the first output, a first communication profile, wherein the first communication profile includes an indication of one or more domains of a plurality of domains for the first textual communication and one or more confidence indicators, wherein each confidence indicator of the one or more confidence indicators corresponds to an associated domain of the one or more domains;
determining, based on the indication of the one or more domains and the one or more confidence indicators, that the first communication profile satisfies first criteria or second criteria;
based on the first communication profile satisfying the first criteria:
determining one or more rulesets corresponding to the one or more domains; and
providing, according to the one or more rulesets, the first textual communication to the second model to generate, for display on a user interface, a second output; and
based on the first communication profile satisfying the second criteria, causing execution of a termination protocol in lieu of providing, according to the one or more rulesets, the first textual communication to the second model to generate, for display on the user interface, the second output.

3. The method of claim 2, further comprising:
determining a plurality of rulesets corresponding to the plurality of domains;
monitoring generation of the second output to detect that at least a portion of the second output satisfies a first rule of a first ruleset corresponding to the one or more domains; and
based on detecting that at least the portion of the second output satisfies the first rule, causing the execution of the termination protocol prior to completing generation of the second output.

4. The method of claim 3, further comprising:
generating a cache record, wherein the cache record comprises the first textual communication, first rule of the first ruleset, and at least the portion of the second output;
storing the cache record in a user cache associated with a user device;
receiving a second textual communication;
determining, based on the user cache, that the second textual communication relates to at least a portion of the first textual communication; and
based on determining that the second textual communication relates to at least the portion of the first textual communication, causing the execution of the termination protocol.

5. The method of claim 2, further comprising:
determining a plurality of rulesets corresponding to the plurality of domains;
monitoring generation of the second output to detect that at least a portion of the second output satisfies a first rule of a first ruleset corresponding to the one or more domains and that at least the portion of the second output does not satisfy a second rule of a second ruleset corresponding to the one or more domains, wherein the first ruleset is associated with a first domain of the plurality of domains and the second ruleset is associated with a second domain of the plurality of domains; and
based on detecting that at least the portion of the second output satisfies the first rule and that at least the portion of the second output does not satisfy the second rule, providing the first textual communication to a third model associated with the second domain to generate, for display on the user interface, a third output, the third model comprising a third resource size, wherein the third resource size is greater than the first resource size.

6. The method of claim 2, wherein providing the first textual communication to the second model to generate the second output comprises:
determining that a first confidence indicator of the one or more confidence indicators meets a corresponding threshold confidence value associated with a first domain of the one or more domains;
obtaining user authentication requirements corresponding to the first domain;
transmitting, to a user device associated with a user, a user credential request indicating the user authentication requirements;
receiving, from the user device, user credentials for the user;
determining that the user credentials satisfy the user authentication requirements; and
based on determining that the user credentials satisfy the user authentication requirements, generating, for display on the user interface of the user device, the second output.

7. The method of claim 2, wherein providing the first textual communication to the second model to generate the second output comprises:
determining that a first confidence indicator of the one or more confidence indicators meets a corresponding threshold confidence value associated with a first domain of the one or more domains;
obtaining user authentication requirements corresponding to the first domain;
determining a user identifier corresponding to a user associated with the first textual communication;
obtaining, from a user activity database, user activity data, wherein the user activity data comprises information relating to previous textual communications and corresponding outputs associated with the user;
generating an authentication probability based on the user activity data, wherein the authentication probability indicates a likelihood that the user provides user credentials that satisfy the user authentication requirements;
comparing the authentication probability with a threshold authentication probability;
determining that the authentication probability meets the threshold authentication probability; and
in response to determining that the authentication probability meets the threshold authentication probability, generating, for display on the user interface, the second output.

8. The method of claim 7, further comprising:
determining that the authentication probability does not meet the threshold authentication probability; and
in response to determining that the authentication probability does not meet the threshold authentication probability, causing the execution of the termination protocol prior to completing generation of the second output.

9. The method of claim 2, wherein providing the first textual communication to the second model to generate the second output comprises:
determining that a first confidence indicator of the one or more confidence indicators meets a corresponding threshold confidence value associated with a first domain of the one or more domains;
determining a user identifier corresponding to a user associated with the first textual communication;
determining, based on the user identifier, a user permission status for the user, wherein the user permission status indicates user access to outputs corresponding to the first domain; and
based on the user permission status, generating, for display on the user interface, the second output.

10. The method of claim 2, wherein providing, according to the one or more rulesets, the first textual communication to the second model comprises:
determining, based on the one or more rulesets, a plurality of control tokens, wherein each control token of the plurality of control tokens indicates a forbidden natural language token;
monitoring generation of the second output to detect that at least a portion of the second output includes a first token of the plurality of control tokens; and
based on detecting that at least the portion of the second output includes the first token, causing the execution of the termination protocol prior to completing generation of the second output.

11. The method of claim 2, wherein causing the execution of the termination protocol comprises:
generating a termination message, wherein the termination message comprises an indication of the one or more confidence indicators; and
generating, for display on the user interface, the termination message.

12. The method of claim 2, wherein causing the execution of the termination protocol comprises:
generating communication metadata, wherein the communication metadata comprises at least a portion of the first textual communication, at least a portion of the first output, a timestamp, and a user identifier of a user associated with the first textual communication;
generating, based on the communication metadata, a candidate ruleset;
transmitting, to an administrator system, the candidate ruleset;
obtaining, from the administrator system, a first ruleset associated with a first domain; and
generating the one or more rulesets to include the first ruleset.

13. The method of claim 2, wherein generating the first communication profile comprises:
generating a communication summary, wherein the communication summary comprises the first textual communication and the first output;
providing the communication summary to a classification model to generate a semantic classification, wherein the semantic classification comprises a categorization of semantic content associated with the communication summary; and
generating the first communication profile to include a first domain, wherein the first domain corresponds to the semantic classification.

14. The method of claim 13, further comprising:
generating, using the classification model, a first confidence metric associated with the semantic classification, wherein the first confidence metric indicates an estimated likelihood that the semantic classification corresponds to a ground-truth semantic classification for the communication summary; and
generating the first communication profile to include the first confidence metric.

15. The method of claim 2, further comprising:
receiving a second textual communication;
providing the second textual communication to the first model to generate a third output;
generating, based on the second textual communication and the second output, a second communication profile, wherein the second communication profile comprises a first domain;
determining that the second communication profile satisfies the first criteria;
based on determining that the second communication profile satisfies the first criteria, determining that the first domain does not correspond to the one or more domains; and
based on determining that the first domain does not correspond to the one or more domains, providing, according to a first ruleset associated with the first domain, the second textual communication to the second model to generate a fourth output.

16. The method of claim 2, wherein providing the first textual communication to the second model to generate the second output comprises:
determining that the first output includes a control token, wherein the control token includes a prohibited word, phrase, or sentence;
monitoring generation of the second output to detect that at least a portion of the second output includes the control token; and
based on detecting that at least the portion of the second output includes the control token, generating, for display on the user interface, a modified second output, wherein the modified second output does not include the control token.

17. One or more non-transitory, computer-readable media storing instructions that, when executed by one or more processors, cause operations comprising:
receiving a first textual communication;
obtaining, via a first model, a first output based on the first textual communication;
generating, based on the first textual communication and the first output, a first communication profile, wherein the first communication profile includes an indication of one or more domains of a plurality of domains for the first textual communication and one or more confidence metrics, wherein each confidence indicator of the one or more confidence metrics corresponds to an associated domain of the one or more domains;
determining, based on the indication of the one or more domains and the one or more confidence metrics, that the first communication profile satisfies first criteria or second criteria;
based on the first communication profile satisfying the first criteria:
determining one or more rulesets corresponding to the one or more domains; and
obtaining, via a second model according to the one or more rulesets, a second output based on the first textual communication; and
based on the first communication profile satisfying the second criteria, causing execution of a termination protocol in lieu of providing, according to the one or more rulesets, the first textual communication to the second model to generate the second output.

18. The one or more non-transitory, computer-readable media of claim 17, wherein the instructions cause operations further comprising:
determining a plurality of rulesets corresponding to the plurality of domains;
monitoring generation of the second output to detect that at least a portion of the second output satisfies a first rule of a first ruleset corresponding to the one or more domains; and
based on detecting that at least the portion of the second output satisfies the first rule, causing the execution of the termination protocol prior to completing generation of the second output.

19. The one or more non-transitory, computer-readable media of claim 18, wherein the instructions cause operations further comprising:
generating a cache record, wherein the cache record comprises the first textual communication, the first rule of the first ruleset and at least the portion of the second output;
storing the cache record in a user cache associated with a user device;
receiving a second textual communication;
determining, based on the user cache, that the second textual communication relates to at least a portion of the first textual communication; and
based on determining that the second textual communication includes at least the portion of the first textual communication, causing the execution of the termination protocol.

20. The one or more non-transitory, computer-readable media of claim 17, wherein the instructions cause operations further comprising:
determining a plurality of rulesets corresponding to the plurality of domains;
monitoring generation of the second output to detect that at least a portion of the second output satisfies a first rule of a first ruleset corresponding to the one or more domains and that at least the portion of the second output does not satisfy a second rule of a second ruleset corresponding to the one or more domains, wherein the first ruleset is associated with a first domain of the plurality of domains and the second ruleset is associated with a second domain of the plurality of domains; and
based on detecting that at least the portion of the second output satisfies the first rule and that at least the portion of the second output does not satisfy the second rule, providing the first textual communication to a third model associated with the second domain to generate a third output, the third model comprising a third resource size, wherein the third resource size is greater than a first resource size of the first model.
